(19) United States
(12) Patent Application Publication
(10) Pub. No.: US 2010/0229171 A1
(43) Pub. Date: Sep. 9, 2010

(54) MANAGEMENT COMPUTER, COMPUTER SYSTEM AND PHYSICAL RESOURCE ALLOCATION METHOD

(75) Inventors: Satoshi YOSHIMURA, Yokohama (JP); Shinji HOTTA, Kawasaki (JP); Yongguang JIN, Yokohama (JP); Toshiki KUNIMI, Yokohama (JP)

Correspondence Address: BRUNDIDGE & STANGER, P.C., 2318 MILL ROAD, SUITE 1020, ALEXANDRIA, VA, 22314, US

(73) Assignee: HITACHI, LTD., Tokyo (JP)

(21) Appl. No.: 12/700,061

(22) Filed: Feb. 4, 2010

(30) Foreign Application Priority Data
Mar. 6, 2009 (JP) 2009-052922

(51) Int. Cl. G06F 9/455

(52) U.S. Cl. 718/1

(57) ABSTRACT

A management computer to allocate a physical resource in a virtual system includes a section to create a physical source management table including physical resource managing data, a section to create an allocation policy table to manage allocation policies for physical resources, a section to create a configuration information management table to manage Logical PARtition (LPAR) configuration information, and a physical resource allocation judge section to select, based on these tables, an appropriate physical resource be allocated to an LPAR.

### INCORPORATION BY REFERENCE

The present application claims priority from Japanese application JP 2009-052922 filed on Mar. 6, 2009, the content of which is hereby incorporated by reference into this application.

### BACKGROUND OF THE INVENTION

The present invention relates to a technique to assign or to allocate physical hardware resources at timing of, for example, creation and/or deletion of a virtual computer in a virtual system.

US2008/0162983A1 (Baba et al.) describes a technique of a system changeover at occurrence of failure in a server virtual environment in a High Availability (HA) configuration. According to the technique, a cluster program to monitor a guest Operating System (OS) on a host OS is employed to select an appropriate HA configuration based on an HA requirement of a job of a user, to thereby conduct a system changeover at occurrence of failure.

### SUMMARY OF THE INVENTION

Although US2008/0162983A1 (Baba et al.) describes a method to select a system changeover destination at or after occurrence of failure in a cluster system, reference has not been made to which physical resources are to be used (or allocated) by each Logical PARtition (LPAR).

It is therefore an object of the present invention to optimize allocation of physical resources to a virtual computer in a virtual system.

According to an aspect of the present invention, physical hardware is allocated in a virtual system based on information of a configuration of a virtual computer. Specifically, in a computer system including a physical computer on which the virtual computer operates and a management computer which manages the physical computer, a configuration information collecting section and a physical resource information collecting section operate on a virtual program which controls the virtual computer. Various table creating sections which create a physical resource managing table, an allocation policy managing table, and a configuration information managing table by use of the collecting sections operate on the management computer, to thereby control allocation of physical resources based on these tables. Details thereof will be described later.

According to the present invention, it is possible to optimize allocation of physical resources to a virtual computer in a virtual system.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a hardware configuration of a computer system according to the present invention;

FIG. 2 is a block diagram showing a software configuration of a physical computer and a management computer;

FIG. 3 is a diagram showing a layout of a physical resource management table;

FIG. 4 is a diagram showing a layout of a table to explain physical resource allocation conditions;

FIG. 5 is a diagram showing a layout of a table to explain symbols used for physical resource allocation conditions in the physical resource management table;

FIG. 6 is a diagram showing a layout of an allocation policy management table;

FIG. 7 is a diagram showing a state transition diagram for cells constituting a physical resource management table in a state in which an associated device has been allocated;

FIG. 8 is a diagram showing a state transition diagram for cells constituting a physical resource management table in a state in which an associated device has been allocated and in a state in which an associated unit has been allocated;

FIG. 9 is a diagram showing a state transition diagram for cells constituting a physical resource management table in a device unallocated state and a unit unallocated state;

FIG. 10 is a flowchart showing processing in a physical resource allocation judge section;

FIG. 11A is a flowchart showing processing in a physical resource allocation judge section;

FIG. 11B is a flowchart showing processing in a physical resource allocation judge section;

FIG. 12A is a diagram showing an example of a physical resource management table when an allocation policy management table of an LPAR includes allocation with exclusive association in a closed system of a virtual system;

FIG. 12B is a diagram showing examples of allocation policy management tables of respective LPARs when an allocation policy management table of an LPAR includes allocation with exclusive association in a closed system of a virtual system;

FIG. 12C is a diagram showing examples of allocation policy management tables of respective LPARs when an allocation policy management table of an LPAR includes allocation with exclusive association in a closed system of a virtual system;

FIG. 13A is a diagram showing an example of a physical resource management table when an allocation policy management table of an LPAR includes allocation with shared association in two virtual systems;

FIG. 13B is a diagram showing examples of allocation policy management tables of respective LPARs when an allocation policy management table of an LPAR includes allocation with shared association in two virtual systems;

FIG. 13C is a diagram showing examples of allocation policy management tables of respective LPARs when an allocation policy management table of an LPAR includes allocation with shared association in two virtual systems;

FIG. 14A is a diagram showing an example of a physical resource management table when allocation is successfully carried out with an alternative allocation condition in one virtual system;

FIG. 14B is a diagram showing an example of an allocation policy management tables of respective LPAR when allocation is successfully carried out with an alternative allocation condition in one virtual system;

FIG. 14C is a diagram showing an example of an allocation policy management tables of respective LPAR when allocation is successfully carried out with an alternative allocation condition in one virtual system;

FIG. 15 is a diagram showing a layout of a configuration information management table;

FIG. 16A is a flowchart showing processing in a physical resource management table creating section, an allocation policy management table creating section, and a physical resource allocation judge section at system activation and at LPAR creation;

FIG. 16B is a flowchart showing processing in a physical resource management table creating section, an allocation policy management table creating section, and a physical resource allocation judge section at system activation and at LPAR creation;

FIG. 17 is a flowchart showing processing in a physical resource management table creating section, an allocation policy management table creating section, and a physical resource allocation judge section at LPAR deletion;

FIG. 18 is a flowchart showing processing in an allocation policy management table creating section and a physical resource allocation judge section at LPAR update;

FIG. 19 is a flowchart showing processing in a physical resource management table creating section and a physical resource allocation judge section at occurrence of LPAR failure;

FIG. 20 is a flowchart showing processing in a configuration information management table creating section in a management computer;

FIG. 21 is a diagram showing a layout of a correspondence table between allocation conditions and weight values;

FIG. 22 is a diagram showing a layout of a correspondence table between identifiers and associated physical resources;

FIG. 23 is a diagram showing a layout of a correspondence table between priority levels and associated weight values;

FIG. 24 is a diagram showing layouts of an allocation policy management table and a priority table indicating priority levels assigned according to the allocation policy management table;

FIG. 25A is a diagram showing layouts of allocation policy management tables including LPAR priority levels;

FIG. 25B is a diagram showing layouts of allocation policy management tables including LPAR priority levels;

FIG. 26 is a diagram showing a layout of a priority table of LPAR selection priority in the LPAR creation order; and

FIG. 27 is a diagram showing a layout of a priority table of LPAR selection priority according to job groups.

### DESCRIPTION OF THE EMBODIMENTS

Referring now to the accompanying drawings, description will be given of embodiments according to the present invention.

In the drawings associated with the embodiments, the physical computer is clearly discriminated from the management computer and the numbers thereof are limited for easy understanding of the present invention. However, the present invention is applicable to any situation in which the physical computer is not discriminated from the management computer and a plurality of physical computers and a plurality of physical computers are arranged.

### <<Introduction>>

As described above, the present invention optimizes allocation of physical resources to a virtual computer in a virtual system. However, if the allocation cannot be optimized, problems take place as follows.

First, in the general conventional technique, consideration has not been given to physical resource allocation which meets requirements of efficient use of physical resources, securing of independence of LPARs to prevent double failure due to failure of one and the same physical resource of an HA system, and securing of system independence to guarantee security of a Storage Area Network (SAN) and to prevent interception of information via a Virtual Local Area Network (VLAN). This leads to a first problem of insufficient reliability and security.

The first problem may be removed by exclusively allocating physical resources to all LPARs (to allocate a physical resource to only one associated LPAR). However, this method leads to a second problem. There cannot be achieved the efficient use of resources by the shared allocation of physical resources (to allocate a physical resource to two or more LPAR) which is one of the aspects of the virtual system.

Also, the first problem may be solved if the user knows allocation of physical resources and the required configuration of each LPAR. That is, appropriate physical resources can be allocated by use of minimum exclusive allocations. However, there arises a third problem. In consideration of a large system configuration, the above solution based on human resources is not possible.

Moreover, when constructing, for example, a High Availability (HA) cluster in a virtual system, the user must conduct the allocation by paying attention to the mapping between resources to be allocated in the virtual system and physical resources. This leads to a fourth problem that heavier load is imposed on the user as compared with the system construction in a physical system.

Hence, the optimization of physical resource allocation according to the present invention is specifically as follows. The efficient use (shared allocation) of resources which is one aspect of the virtual system and the securing (exclusive allocation) of independence of the system for security are guaranteed on the system side without any intervention of the user.

Bearing this situation in mind, description will now be given of embodiments.

### Embodiment 1

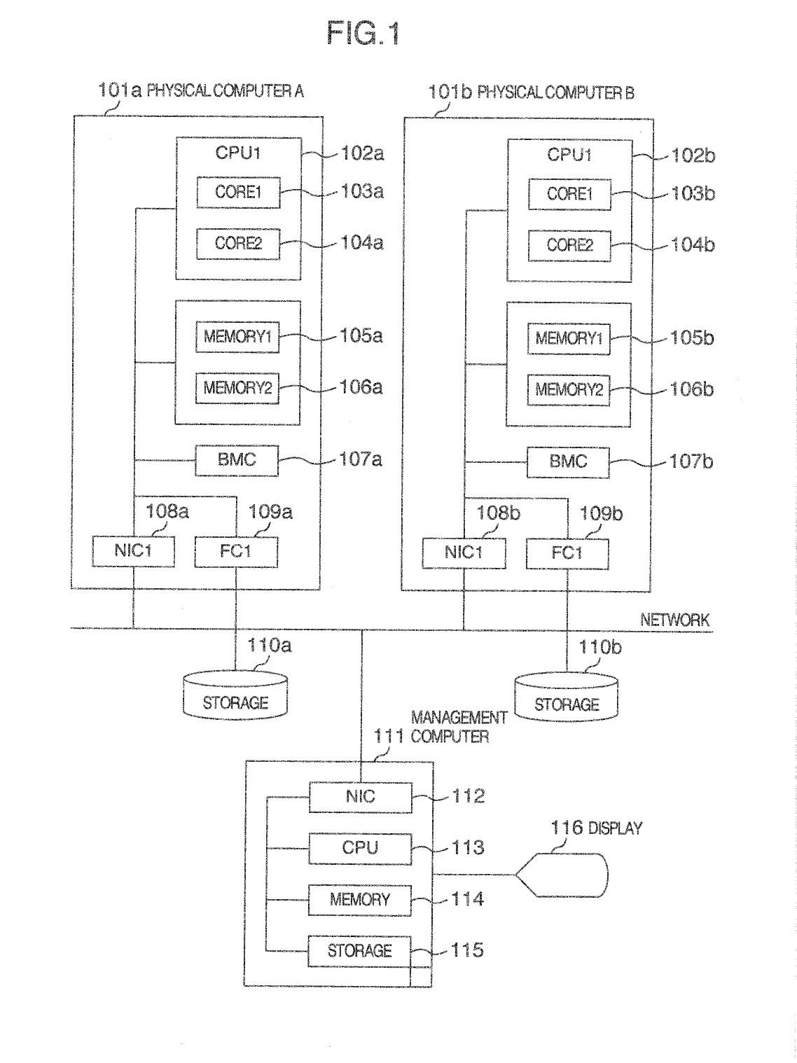

FIG. 1 shows a hardware configuration of a computer system (to be simply referred to as “system” depending on cases hereinbelow) according to the present invention. In the embodiment of the system, a plurality of physical computers 101 (two computers, i.e., physical computer A (101a) and physical computer B (101b) in this example) are connected via a network to one management computer 111.

The physical computer 101 is a computer including a Central Processing Unit (CPU; 102a, 102b), a memory 1 (105; 105a, 105b), a memory 2 (106; 106a, 106b), a Baseboard Management Controller (BMC) 107 (107a, 107b), a Network Interface Card (NIC) 108 (108a, 108b), and a Fibre Channel Card (FC) 109 (109a, 109b). The physical computer 101 also includes a display section including a display and the like and an input section including, for example, a mouse and a keyboard.

The CPU 102 executes processing by use of programs stored in the memories 105 and 106. The memories 105 and 106 and a storage 110 (110a, 110b) store data processed by the CPU 102. The NIC 108 communicates via the network with a computer as a communicating party, e.g., a physical or management computer. The CPU 102 includes a core 1 (103; 103a, 103b) and a core 2 (104; 104a, 104b) to concurrently execute various programs such as operating systems.

The memories 105 and 106 are connected via a memory bus to the CPU 102. The management computer 111 is a computer similar in hardware structure to the physical computer 101. In FIG. 1, the management computer 111 includes an NIC 112, a CPU (control section) 113, a memory (memory section) 114, a storage 115, and a display (display section) 116. The management computer 111 also includes an input section including, for example, a mouse and a keyboard.

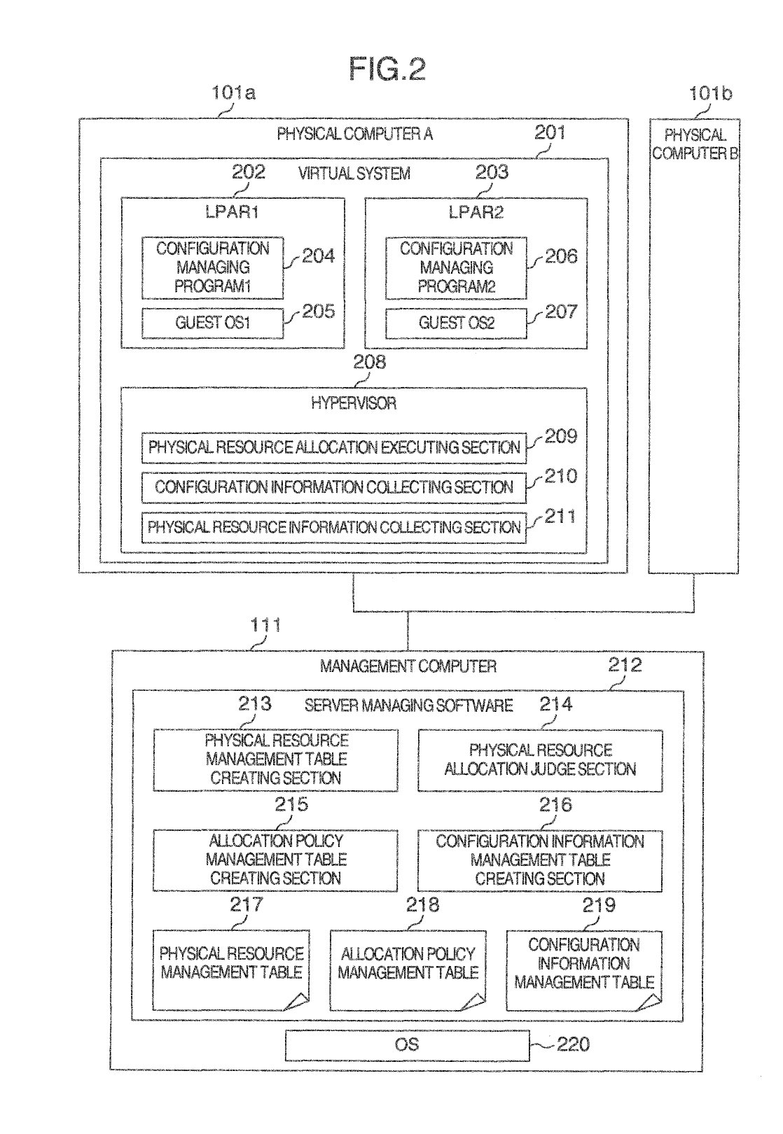

FIG. 2 shows software configurations of the physical and management computers in a block diagram. For easy understanding, description will be given of the configurations by paying attention to physical computer A (101a).

In physical computer A (101a), a hypervisor 208 which operates in a virtual system 201 constructs Logical PARtitions (LPARs; virtual computers), to thereby provide LPARs. In the LPAR 1 (202), a guest operating system 1 (205) is running. On the guest OS 1 (205), there is operating, for example, a configuration managing program 1 (204) which serves as an HA cluster function between logical partitions. A logical partition 2 (203) is similar in structure to the LPAR 1 (202). On a guest OS 2 (207), there is operating, for example, a configuration managing program 2 (206) which serves as an HA cluster function between logical partitions.

In physical computer A (101a), the hypervisor 208 includes a physical resource allocation executing section 209, a configuration information collecting section 210, and a physical resource information collecting section 211.

The physical resource allocation executing section 209 includes a function to allocate, at reception of a physical resource allocation request from the hypervisor 208, a physical resource as a logical resource to an associated LPAR.

The configuration information collecting section 210 includes an interface for a configuration managing program which operates in each LPAR, and serves as a function to collect configuration information requested by each LPAR. The configuration information indicates information of association with respect to an LPAR requested by a pertinent LPAR and includes information of exclusive or shared association and an LPAR as an association target.

The physical resource information collecting section 211 includes an interface for the BMC 107 and serves as a function to collect information of the physical computer 101 including physical resource information such as the number of CPUs or cores, the number of memories, the number of NICs or ports, and the number of FCs or ports.

The configuration information collecting section 210 and the physical resource information collecting section 211 transmit collected information pieces via a network to the management computer 111.

Physical computer B (101b) also includes a function similar to that of physical computer A (101a); hence, description thereof will be avoided. The same functional blocks of physical computer B (101b) as those of physical computer A (101a) will be assigned with the same reference numerals.

An operating system 220 is running on the management computer 111. A server managing software 212 operates on the operating system 220.

The server managing software 212 includes a centralized managing function for the hardware configuration of the physical computer 101 and a centralized managing function (creation or deletion of an LPAR, allocation of a physical resource, and management of the configuration information) for the virtual system 201.

Also, the server managing software 212 includes a physical resource management table creating section 213, a physical resource allocation judge section 214, an allocation policy management table creating section 215, and a configuration information management table creating section 216.

The physical resource management table creating section 213 receives physical resource information of the physical computer 101 from the physical resource information collecting section 211 of the virtual system 201 of the physical computer 101 to create a physical resource management table 217 including elements such as the physical resource and the maximum number of logical partitions of the virtual system 201.

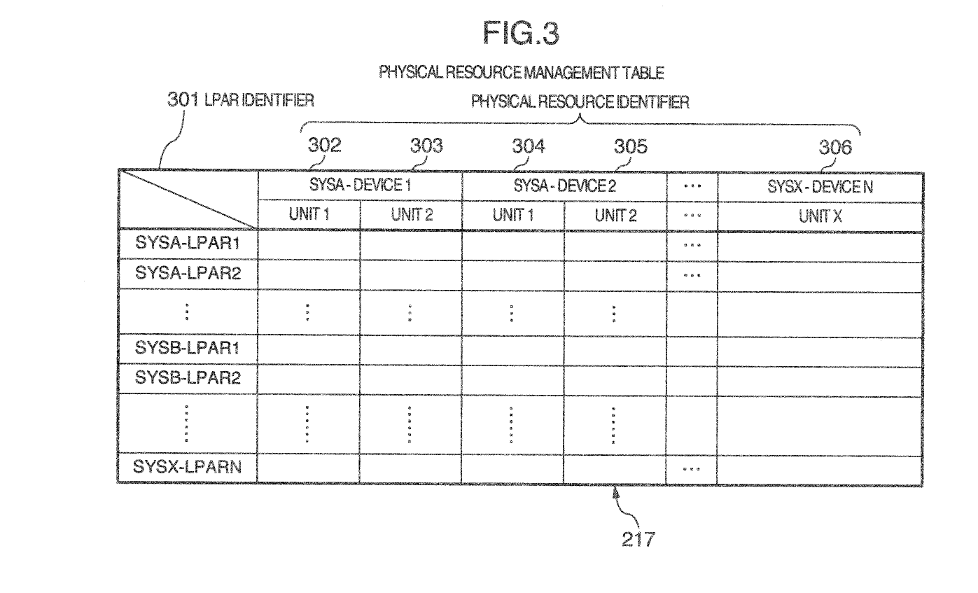

FIG. 3 shows a layout of the physical resource management table 217.

As FIG. 3 shows, the table 217 for physical resource managing information includes an LPAR identifier 301 and physical resource identifiers of respective types 302 to 306 (this example does not restrict the number of physical resource identifiers). To discriminate each of the running physical computers, the LPAR identifier 301 includes a physical computer name (e.g., SYS A for physical computer A (101a); omissible item) and an LPAR number (e.g., LPAR1) and is represented as, for example, SYS A-LPAR1. Using this information, an allocation state regarding allocation of physical resources is registered for each LPAR. The allocation state will be described later.

The physical resources are classified according to concepts of “device” and “unit”. For example, for CPUs, the devices are classified according to CPUs (sockets) and the units are classified according to cores. For the physical resource identifiers of respective types 302 to 306, each device is identified by a physical computer name (e.g., SYS A) and a device name (e.g., device 1), namely, as SYS A-device 1. Each unit is identified by a unit name, e.g., unit 1. The physical resource management table 217 is created and is managed for each physical resource. The table 217 is created or updated at timing of activation of a virtual program which is not shown and which controls the virtual system 201.

Based on association information between LPARs obtained from a user request to allocate a physical resource to an LPAR or from the configuration information management table 219, the allocation policy management table creating section 215 creates the allocation policy management table 218 for each LPAR.

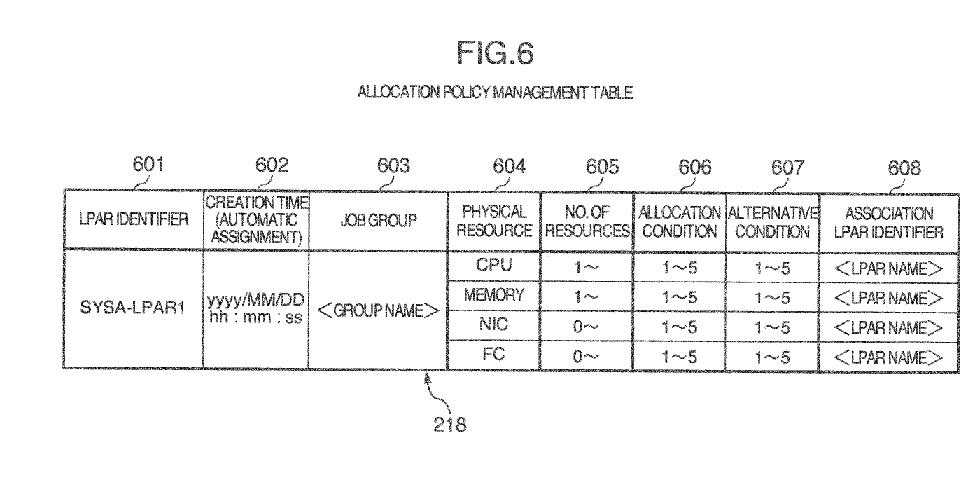

FIG. 6 shows a layout of the allocation policy management table 218.

As FIG. 6 shows, the table 218 for allocation condition managing information includes an LPAR identifier 601, a creation time 602 indicating an LPAR creation time (to be referred to also as LPAR generation time in some cases) when a value is inputted by a user's operation to the table 218 (when a logical partition is secured for a virtual computer on a virtual program), a job group 603 indicating a group associated with a job to which the LPAR belongs (a service of an application implemented by use of a logical resource of the LPAR), a physical resource 604 indicating a physical resource type, a number of physical resources 605 indicating the number of physical resources requested for allocation, a physical resource allocation condition 606, an alternative condition 607 for use at failure of allocation using the allocation condition 606, and an association LPAR identifier 608 for registration of an LPAR name of an LPAR associated with the pertinent LPAR at request of exclusive or shared association. The allocation policy management table 218 is created and is managed for each LPAR. The table 218 is associated with each LPAR row (LPAR identifier 301) of the physical resource management table 217 and is created at creation of the physical resource management table 217. The number of tables 218 to be created is limited by the maximum number of LPARs.

It is favorable that the alternative condition is looser than the allocation condition for which allocation has failed. This is because the alternative condition is an allocation condition disposed to successfully carry out the allocation. However, this is not limitative depending on the system configuration.

The configuration information management table creating section 216 receives, from the configuration information collecting section 210 of the virtual system 201 of the physical computer, configuration information of each LPAR of the virtual system 201 to create the configuration information management table 219 including elements such as the type of the physical resource and the maximum number of LPARs of the virtual system 201.

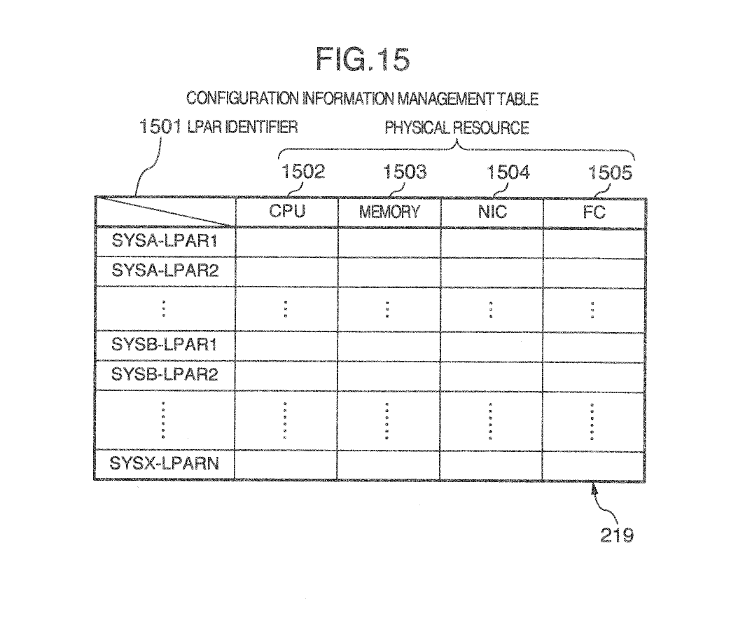

FIG. 15 shows a layout of the configuration information management table 219.

As can be seen from FIG. 15, the table 219 for configuration information managing information includes an LPAR identifier 1501 and various physical resources 1502 to 1505 allocatable to a virtual computer (this example does not limit the number of available physical resources). The table 219 is employed to manage configuration information including association information to determine presence or absence of a virtual computer (i.e., an LPAR) requested for association from a redundant program which is not shown and which operates on a guest operating system of a virtual computer, an LPAR as an association source, and an LPAR as an association destination. The table 219 is created or updated at activation of a virtual program which controls the virtual system.

The physical resource allocation judge section 214 reads the allocation policy management table 218 for the LPAR at creation of the LPAR to confirm an allocation condition (606 in FIG. 6) of each physical resource to the LPAR. The judge section 214 compares the allocation condition of the pertinent physical resource to the LPAR with the state in the field of the LPAR row and the physical resource column such as the physical resource identifier 302 of the physical resource management table 217. If the allocation condition is valid, the judge section 214 updates the table 217. If the allocation conditions of the physical resources requested by the LPARs created in all virtual systems are satisfied, the judge section 214 sends an allocation request according to the table 217 to the physical resource allocation executing section 209.

Description will now be given of an allocation condition of a physical resource.

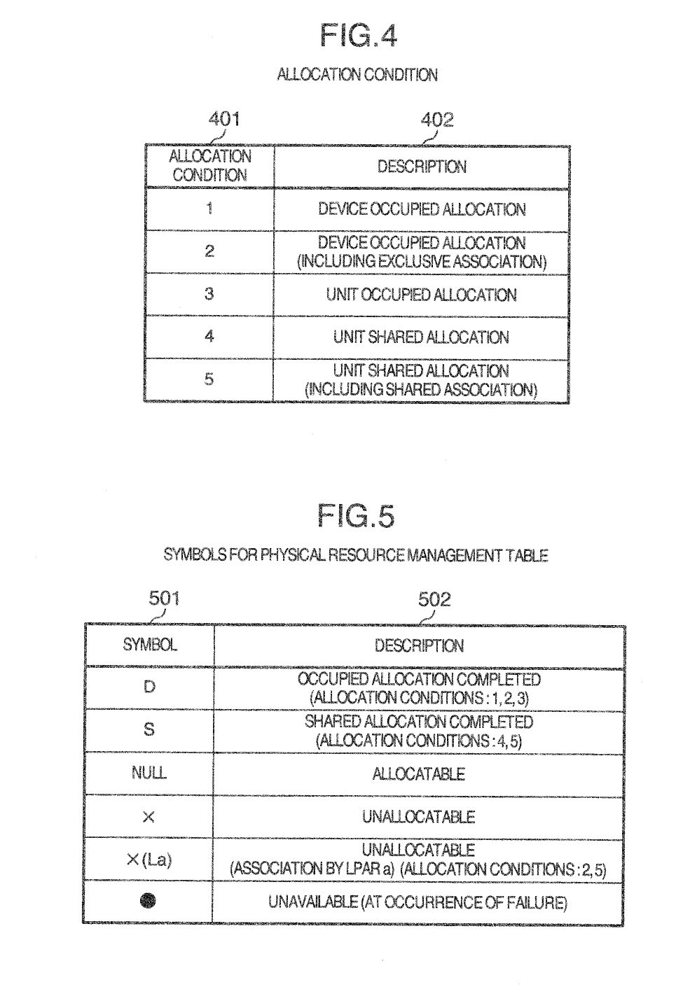

FIG. 4 shows a table to explain the physical resource allocation condition.

As described in FIG. 4, allocation conditions 401 include five allocation methods, i.e., device occupied allocation, device occupied allocation including LPAR exclusive association, unit occupied allocation, unit shared allocation, and unit shared allocation including LPAR shared association.

According to the device occupied allocation (allocation condition 1), a unit constituting the associated device is allocated to the target LPAR in an occupied state. A device designated with the device occupied allocation cannot be allocated to any other LPAR even if the device includes a free or available unit. By use of this allocation condition, the physical resource to be allocated is occupied in the device unit. That is, the condition is disposed to prevent occurrence of one of the problems, namely, the double failure due to the sharing of one and the same physical resource (device).

According to the device occupied allocation including LPAR exclusive association (allocation condition 2), the device is allocated such that the device is not shared by the specified LPAR. This condition is effective to construct an HA cluster between LPARs in a virtual system. The sharing of the device by the associated LPAR is prevented (excluded) while the sharing of the device by any other LPAR is allowed. Hence, the physical resource is efficiently used while preventing the double failure.

According to the unit occupied allocation (allocation condition 3), the unit is allocated to a specified target LPAR in an occupied state. In the device of the unit designated with the unit occupied allocation, any other unit of the device may be allocated to a desired LPAR other than the target LPAR. This allocation condition is similar to the physical resource occupied allocation of the prior art.

According to the unit shared allocation (allocation condition 4), it is allowed that the unit is shared among a plurality of LPARs. This allocation condition is similar to the physical resource shared allocation of the prior art. By sharing the unit among a plurality of LPARs, it is possible to efficiently allocate physical resources.

According to the unit shared allocation including LPAR shared association'(allocation condition 5), it is allowed that the unit is shared by only a designated LPAR. This allocation condition is effectively employed for an LPAR which uses the SAN security and the VLAN. For a system and a job, the unit sharing is allowed only for the designated LPAR. This hence removes the problem of security such as unauthorized information interception through the unit sharing.

FIG. 5 shows a table layout to explain symbols of physical resource allocation conditions employed in the physical resource allocation management table.

As FIG. 5 shows, allocation states are represented by a symbol 501 for allocation conditions 1 to 5 described above. In the physical resource allocation management table 217, these states are managed using the symbols 501, specifically, D, S, null, X, X(La), and . These symbols indicate allocation states as described in the respective fields 502. In the symbols, La indicates a requested LPAR name, for example, an LPAR having a name “a” requested by the user for allocation.

Next, description will be given of the state transition using the allocation state symbols in the physical resource allocation management table 217.

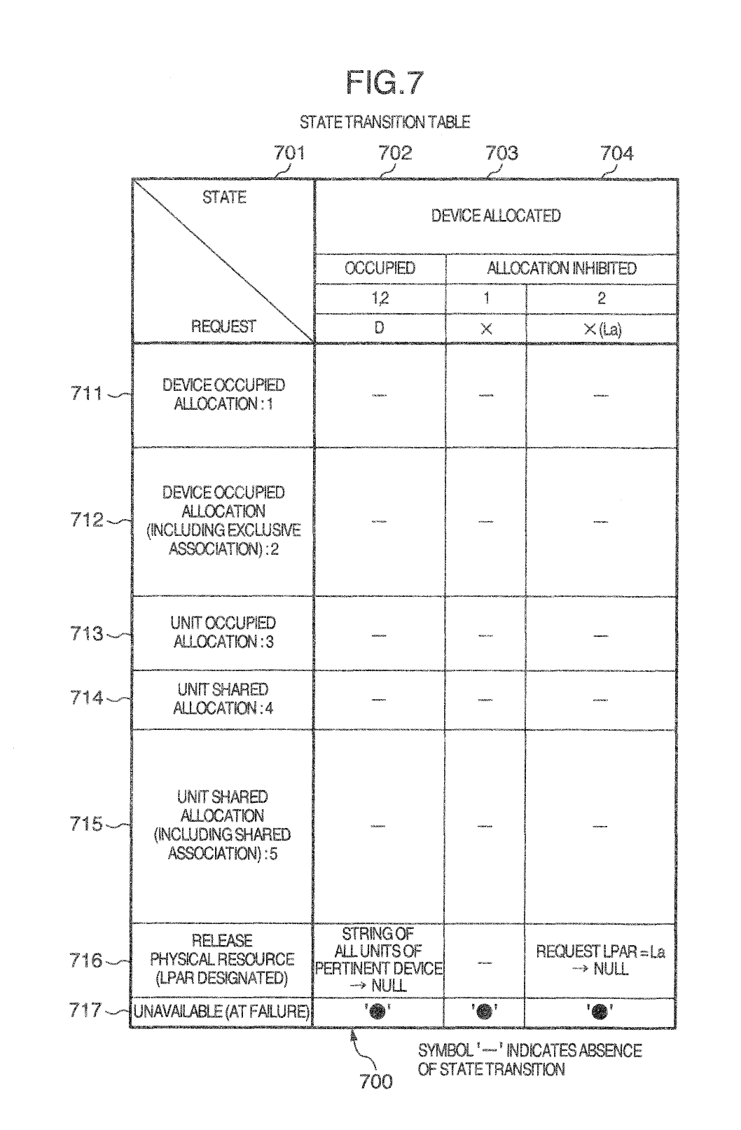

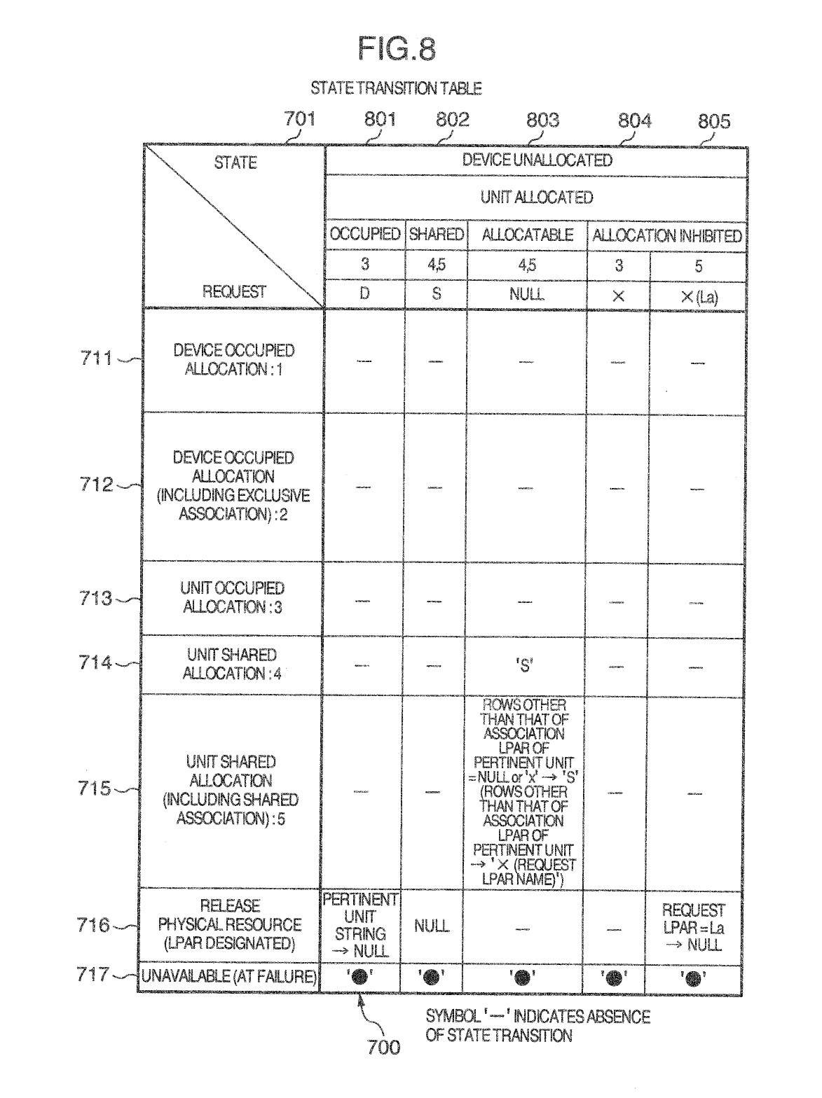

FIGS. 7 to 9 each show a table layout to explain state transitions of cells constituting the table 217. Each of these tables will be referred to as a state transition table 700.

The state transition table 700 represents a state (symbol) transition when a request of an LPAR is issued for a cell in the physical resource allocation management table 217. The table 700 includes a request for LPAR 701 and fields 702 to 704, 801 to 805, 901, and 902 indicating states of respective cells. The state of each cell is expressed by the symbols shown in FIG. 5.

For a request of device occupied allocation (allocation condition 1) 711, if the cell to receive the request is in a state in which the device thereof has been allocated by another request as indicated in the fields 702 to 704, the cell state is kept unchanged.

Also when the state of the target cell is in a state in which the device thereof has not been allocated and the unit has been allocated by another LPAR as indicated in the fields 801 to 805, the cell state is kept unchanged.

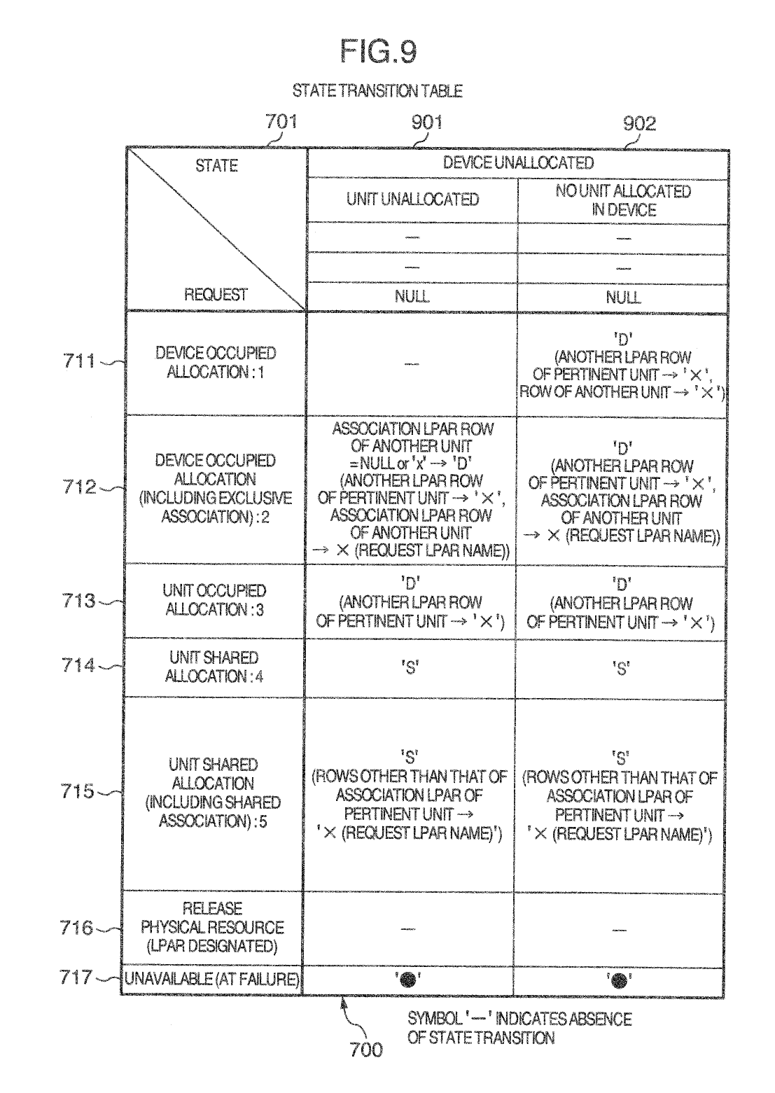

As FIG. 9 shows, if the target unit has not been allocated as indicated in the field 901 and another unit of the same device has been allocated, the cell state is kept unchanged.

If none of the units of the device has been allocated as indicated in the field 902, the symbol of the target cell is changed to “D” and the symbols of the other LPAR fields of the pertinent unit and all LPAR fields of the other unit of the same device are changed to “X”.

As a result, the device occupied allocation is carried out for the target LPAR only if none of the devices and the units has been allocated with a physical resource.

For a request of device occupied allocation including LPAR exclusive association (allocation condition 2) 712, in a situation as indicated in the fields 702 to 704 and 801 to 805, the state of the target cell is kept unchanged.

The field 901 indicates that the target unit has not been allocated. If the association LPAR fields of the other units are null or “X”, the target cell is changed to “D”. The other LPAR fields of the pertinent unit are changed to “X”. The association LPAR fields of the other units of the same device are changed to “X (requested LPAR name)”.

The field 902 indicates that none of the units of the device has been allocated. Hence, the target cell is changed to “D”. The other LPAR fields of the pertinent unit are changed to “X”. The association LPAR fields of the other units of the same device are changed to “X (requested LPAR name)”.

In this way, the device occupied allocation is carried out for the target LPAR while preventing the sharing in allocation by the exclusively associated LPAR.

For a request of unit occupied allocation (allocation condition 3) 713, in a situation indicated in the fields 702 to 704 and 801 to 805, the state of the target cell is kept unchanged.

The field 901 indicates that the target unit has not been allocated. Hence, the target cell is changed to “D”. The other LPAR fields of the pertinent unit are changed to “X”.

Similarly, since the field 902 indicates that no unit of the device has been allocated, the target cell is changed to “D”. The other LPAR fields of the pertinent unit are changed to “X”.

In this way, the unit occupied allocation is carried out for the target LPAR.

For a request of unit shared allocation (allocation condition 4) 714, the state of the target cell is kept unchanged in a situation indicated in the fields 702 to 704 and 801 and 802.

The field 803 indicates that the device has not been allocated and the unit allocation has been conducted by another LPAR. The state of the target cell is null and is hence changed to “S”.

The fields 804 and 805 do not affect the state of the target cell.

The field 901 indicates that the target unit has not been allocated. The target cell is changed to “S”.

Similarly, since the field 902 indicates that no unit of the device has been allocated, the target cell is changed to “S”.

In this way, the unit shared allocation is carried out for the target LPAR.

For a request of unit shared allocation including LPAR shared association (allocation condition 5) 715, the state of the target cell is kept unchanged in the situation indicated in the fields 702 to 704 and 801 and 802.

The field 803 indicates that the device has not been allocated and the unit allocation has been conducted by another LPAR. If the fields other than the associated LPAR of the pertinent unit are null or “X”, the state of the target cell is changed to “S”. The fields other than the associated LPAR of the pertinent unit are changed to “X (requested LPAR name”).

The fields 804 and 805 do not affect the state of the target cell.

The field 901 indicates that the target unit has not been allocated. Hence, the state of the target cell is changed to “S”. The fields other than the associated LPAR of the pertinent unit are changed to “X (requested LPAR name”).

Since the field 902 indicates that no unit of the device has been allocated, the state of the target cell is changed to “S”. The fields other than the associated LPAR of the pertinent unit are changed to “X (requested LPAR name”).

In this way, the unit shared allocation is carried out for the target LPAR while allowing the sharing in allocation only by the shared association LPAR.

For a release request to release a physical resource, in the situation indicated in the field 702 (“D”), the state is changed to null. The other unit fields of the pertinent device are also updated to null.

In the state indicated in the field 801 (“D”), the pertinent unit field is updated to null.

In the states indicated in the fields 703, 803, 804, 901, and 902 (“−”), no action is taken.

In the states indicated in the fields 704 and 805 (“X(La)”), the symbol is changed to null only if the LPAR associated with the physical resource release request is substantially equal to La.

In the state indicated in the field 802 (“S”), the symbol is updated to null.

In this way, the physical resource allocation is released from the target LPAR.

If failure takes place in the target physical resource and the resource is unavailable, the fields 702 to 902 are unconditionally updated to “”.

For the requests described above, the associated physical resources have already been unavailable (“”) depending on cases. However, since the resultant state transition is similar to the situation in which “X” is indicated for the physical resources, this situation is not shown in FIGS. 7 to 9.

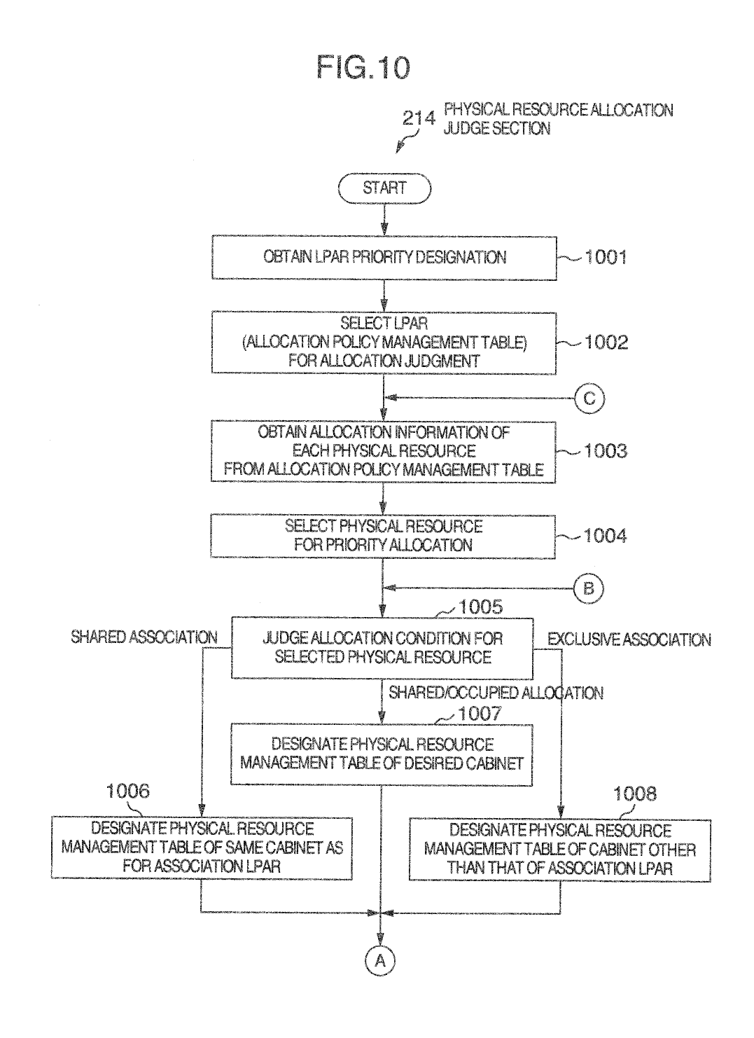

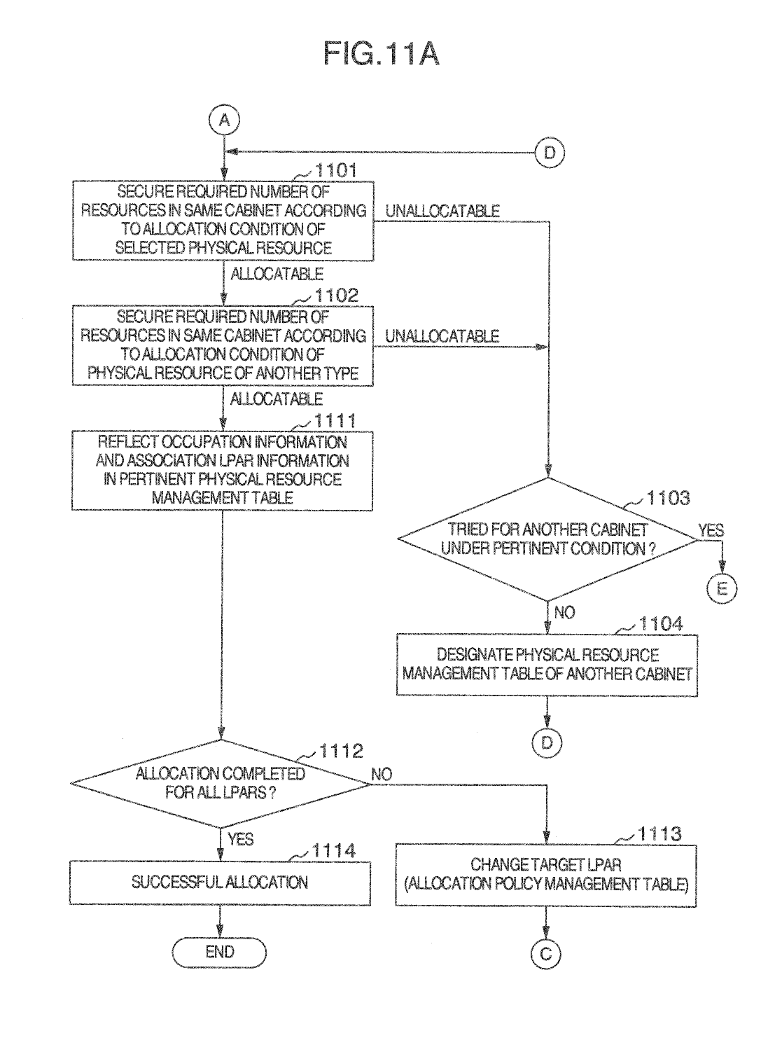

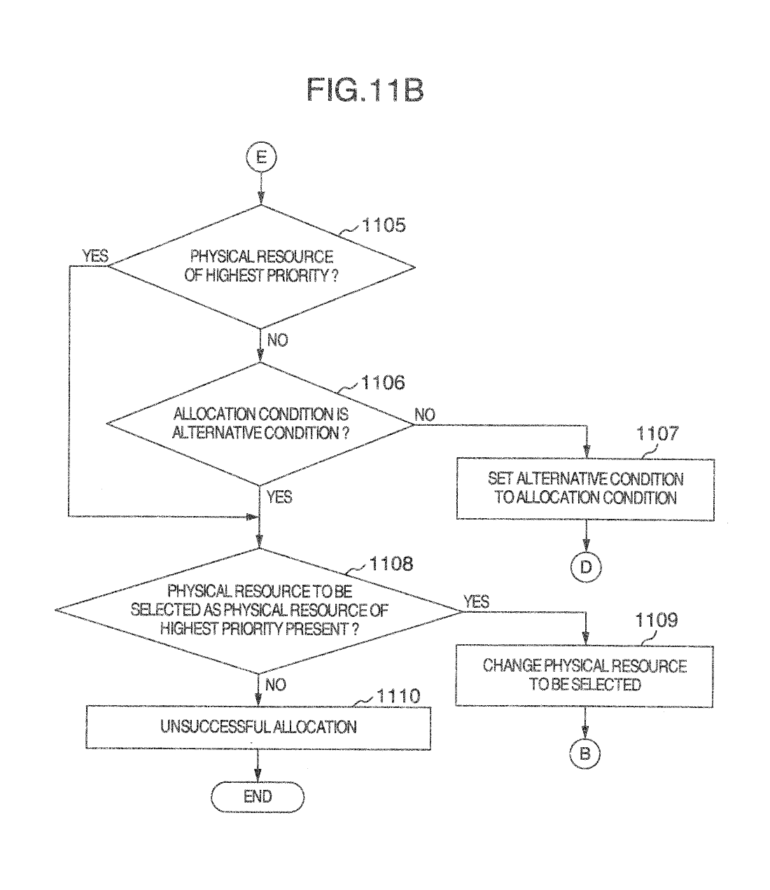

FIGS. 10, 11A, and 11B show flowcharts of processing in the physical resource allocation judge section 214. This is a physical resource allocation flow representing operation of the section 214 at reception of an allocation request. When an allocation condition is indicated or inputted from the user and an LPAR is created, the section 214 starts execution of its processing. Specifically, the processing is primarily executed by the CPU 113.

In step 1001 of the flowchart of FIG. 10, the physical resource allocation judge section 214 obtains an LPAR priority method designated by the user. Kinds of the priority method will be described later in conjunction with embodiment 9.

In step 1002, the judge section 214 selects, one of the LPARs for allocation judgment from the allocation policy management table 218 for the LPARs.

In step 1003, the judge section 214 obtains, from the policy management table 218 associated with the selected LPAR, allocation information of various physical resources. The allocation information mainly includes selection priority assigned to physical resources (priority determined for at least one physical resource allocated to an LPAR), the number of physical resources to be allocated, an allocation condition, an alternative allocation condition, and an association LPAR.

In step 1004, according to the selection priority of the physical resources included in the allocation information, the judge section 214 selects one physical resource for priority allocation.

In step 1005, the judge section 214 judges an allocation condition for the selected physical resource. Based on the allocation condition, the judge section 214 selects a physical computer which provides the physical resource. Assume that the selected allocation condition indicates the exclusive association allocation in a system including a plurality of physical computers. To secure independence of the association LPARs, the judge section 214 points (designates) a physical resource management table of a cabinet (physical computer) other than that of the association LPARs in step 1008, to thereby preferentially select a physical resource other than those of the association LPARs.

Assume that the selected allocation condition indicates the shared association allocation (shared association in step 1005). To select an association LPAR in a closed cabinet and to guarantee security, the judge section 214 designates a physical resource management table 217 of the same cabinet as for the association LPARs, to thereby preferentially select a physical resource of the same physical computer as for the association LPARs.

Assume that the selected allocation condition indicates the shared or occupied allocation (shared/occupied allocation in step 1005). Since the concept of the association LPAR is not present, the judge section 214 designates a physical resource management table 217 of a desired cabinet in step 1007, to thereby select a physical resource of the desired cabinet.

After determining the target of selection for the physical resource, the judge section 214 secures the number of physical resources required for the LPAR, in one and the same cabinet according to the selected allocation condition of physical resources as shown in FIG. 11A. In this step, whether or not the physical resources are securable according to the specified allocation condition is judged. Specifically, the judge section 214 moves the designated physical resource management table 217 to a temporary storage area and confirms whether or not the state transitions shown in FIGS. 7 to 9 are possible. If it is possible to allocate the number of physical resources required for the LPAR (allocatable in step 1101), the judge section 214 confirms in step 1102 whether or not the allocation is similarly possible for physical resources of any other type. That is, also for each remaining type of physical resources, a check is made to determine whether or not the state transitions shown in FIGS. 7 to 9 are possible while securing the number of physical resources of the same cabinet (step 1101) as required by the LPAR.

If the number of physical resources required for the LPAR can be allocated (allocatable in step 1102), the judge section 217 reflects in step 1111 the allocation information for the LPAR (primarily, occupied allocation information (information of occupied information) and association LPAR information) in the physical resource management table 217.

In step 1112, the judge section 214 judges whether or not the allocation has been finished for all LPARs. If the allocation has been finished (yes in step 1112), the judge section 214 assumes that the allocation has been successfully finished and then terminates the processing in step 1114. Otherwise (no in step 1112), the judge section 214 changes the target LPAR and returns to step 1003 to resultantly form a loop in the processing. The processing is repeatedly executed through the loop until the allocation has been successfully finished (step 1114) or the allocation fails for any one LPAR (step 1110).

In step 1101 or 1102, if the number of resources which satisfy the allocation condition and which are required by the LPAR cannot be allocated (unallocatable in step 1101 or 1102), the judge section 214 judges in step 1103 whether or not the securing of the physical resources has been retried for another cabinet (computer) under the same condition (the same processing as step 1102 or 1103). If the securing has not been retried, i.e., if the retry has not been finished for all cabinets (no in step 1103), the judge section 214 designates in step 1104 a physical resource management table 217 of a remaining cabinet and then returns to step 1101.

If it is determined in step 1103 that the retry has been conducted for the remaining cabinet (yes in step 1103), the judge section 214 judges in step 1105 whether or not the pertinent physical resource is a physical resource with the highest priority. If the pertinent physical resource has the highest priority (yes in step 1105), the allocation is to be carried out by using the requested condition. Hence, without employing the alternative allocation condition, the judge section 124 goes to step 1108.

In step 1105, if the pertinent physical resource is other than a physical resource with the highest priority (no in step 1105), the judge section 214 judges in step 1106 whether or not the allocation condition is an alternative allocation condition. If this is not an alternative allocation condition (no in step 1106), the judge section 214 designates in step 1107 the alternative condition set as an allocation policy and then returns to step 1101. If the allocation condition is an alternative allocation condition (yes in step 1106), control goes to step 1108.

In step 1108, a check is made to determine presence or absence of a physical resource which has not been selected as a physical resource with the highest priority. If such unselected physical resource is present (yes in step 1108), the judge section 214 changes the physical resource so that the physical resource with the highest priority is selected as the pertinent physical resource, and then control returns to step 1005. In absence of such unselected physical resource (no in step 1108), the judge section 214 assumes failure of the allocation and then terminates the processing.

Description will be given of operation in which an allocation condition including LPAR exclusive association is applied in a physical resource management table.

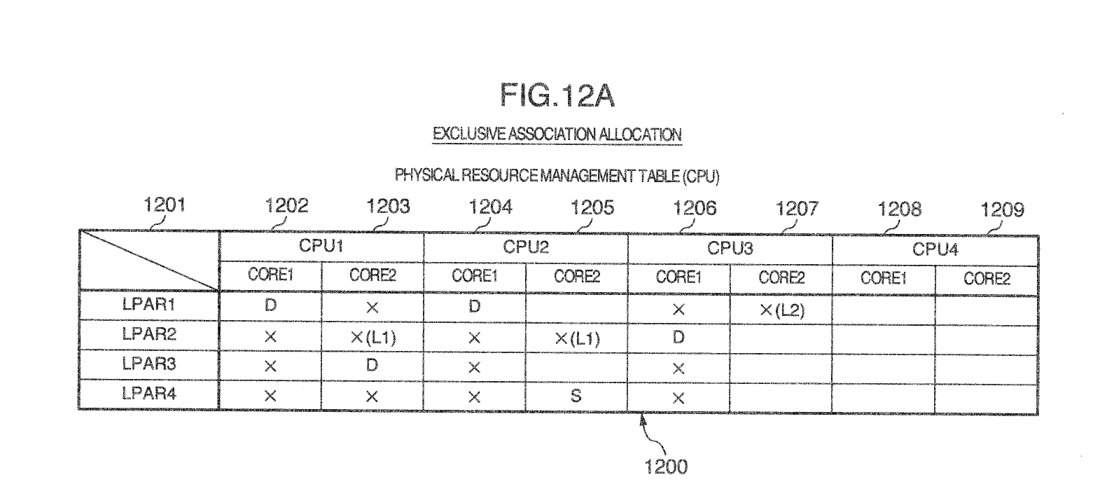

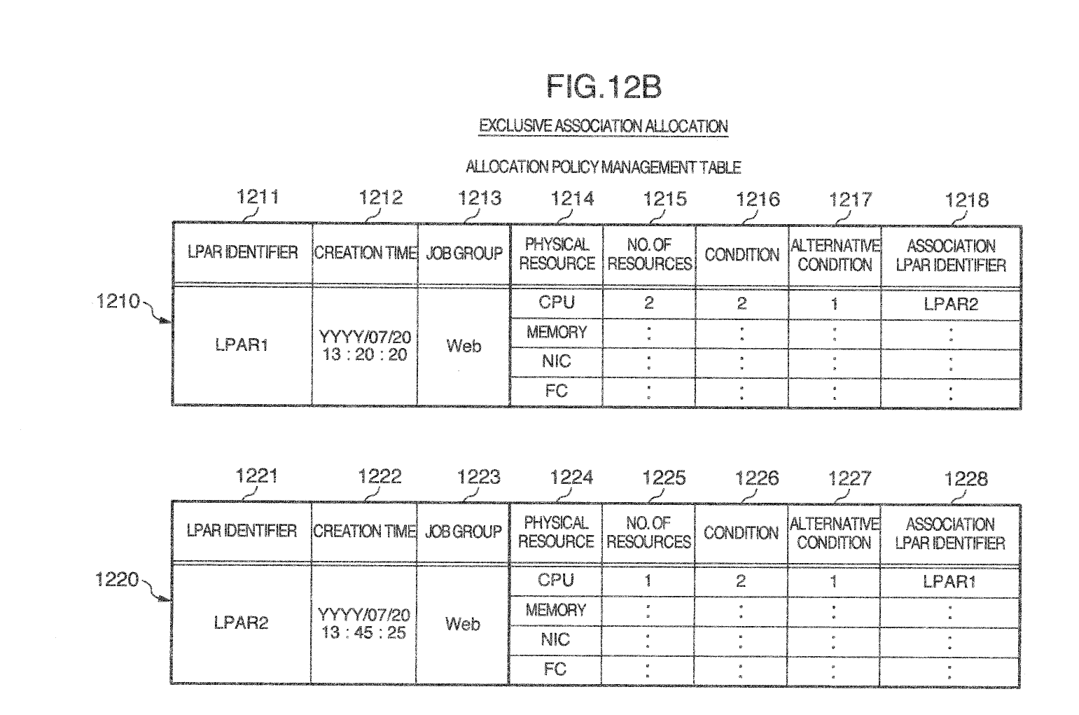

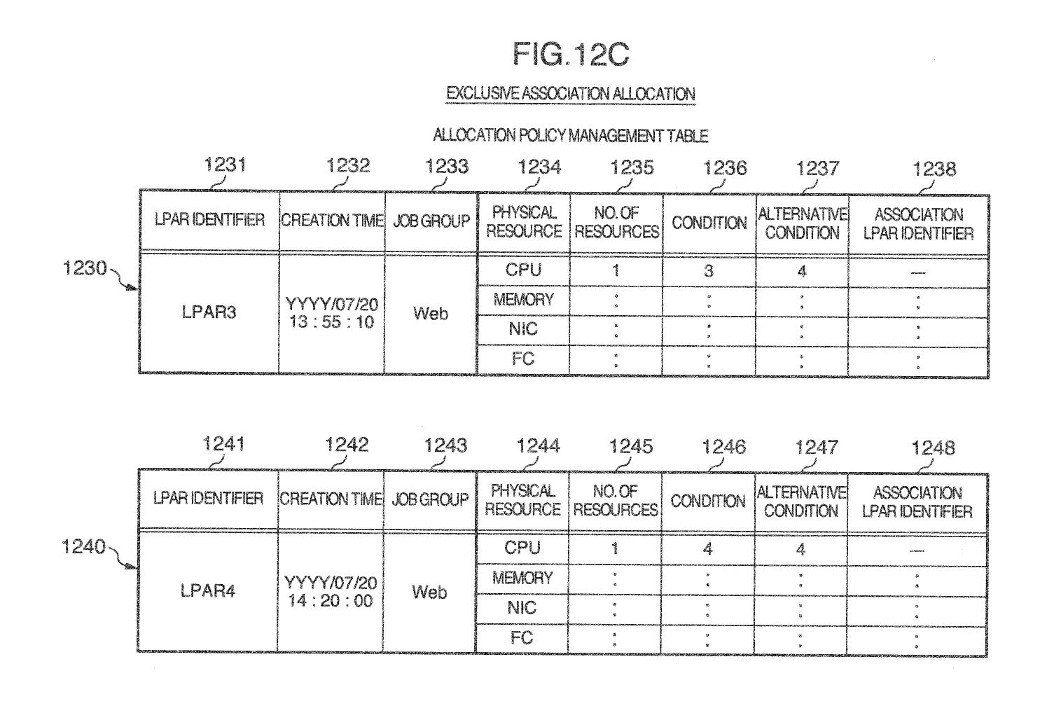

FIGS. 12A to 12C show examples of the physical resource management table and the allocation policy management tables of respective LPARs when an allocation policy management table of an LPAR includes allocation of exclusive association in a closed system of one virtual system. In conjunction with FIGS. 12A to 12C, for simplicity of description, only CPUs are used as physical resources. In the description, reference numeral 1200 indicates a physical resource management table (217 in FIG. 3) and reference numerals 1210 to 1240 indicate allocation policy management tables (218 in FIG. 6).

In the allocation policy management table 1210 of LPAR1, the field of column 1215 or shortly the field 1215 indicates two CPU devices and the fields 1216 and 1218 indicate that a request for device occupied allocation (allocation condition 2) has been issued with exclusive association for LPAR2. The field 1217 indicates that the alternative allocation condition (alternative condition) is device occupied allocation (allocation condition 1). The allocation conditions of the other LPARs are as indicated in FIG. 12 and hence will not be described.

If the allocation policy management table is applied in the creation order of LPARs, the operation is conducted in the sequence of LPAR1, LPAR2, LPAR3, and LPAR2 (reference is to be made to creation times 1212, 1222, 1232, and 1242).

According to the allocation policy management table 1210 of LPAR1, “D” is filled in the field 1202 for LPAR1 of the physical resource management table 1200 and “X” is filled in the other cells of fields 1202. Since the allocation condition indicates exclusive association with LPAR2, “X(L1)” is filled in the field 1203 for LPAR2 (it is to be appreciated that the other fields 1203 are empty at this point of time). LPAR1 requests two CPUs. Hence, also for CPU2 of the fields 1204 and 1205, “D” is filled in the field 1204 for LPAR1, “X” is filled in the other fields 1204, and “X(L1)” is filled in the field 1205 for LPAR2.

Next, on the basis of the allocation policy management table 1220 for LPAR2, an attempt is made to fill data in the fields 1202 to 1205 for LPAR2 of the physical resource management table 1200. However, “X” or “X(L1)” has been inserted therein and hence the attempt fails. Thereafter, “D” is filled in the field 1206 of LPAR2 and “X” is filled in the other fields 1206. Since LPAR2 also requests exclusive association with LPAR1, “X(L2)” is filled in the field 1207 of LPAR1.

According to the allocation policy management table 1230 for LPAR3, one CPU is requested with unit occupied allocation (allocation condition 3). A search is made for an appropriate symbol through the physical resource management table 1200 beginning at the field. 1202 of LPAR2. Since the field 1203 is empty, “D” is filled therein. Since “unit occupied allocation” is designated, “X” is filled in the other fields 1203.

Finally, according to the allocation policy management table 1240 for LPAR4, one CPU is requested with unit shared allocation (allocation condition 4). A search is made for an appropriate symbol through the physical resource management table 1200 beginning at the field 1202 of LPAR4. Since the field 1203 is empty, “D” is filled therein. Since the field 1205 of LPAR4 is empty, “S” is filled therein.

The processing described above is executed by the physical resource allocation judge section 214 of the management computer 111. If it is determined that the requests of all LPARs are satisfied, a request for the allocation of the physical resource management table 217 filled with the symbols is issued to the physical resource allocation executing section 209 of the associated physical computer, to thereby actually execute the allocation of physical resources.

By applying the device occupied allocation including LPAR exclusive association of the embodiment for LPARs constituting an HA cluster system, it is possible to prevent the double failure due to failure of one and the same physical resource (device).

### Embodiment 2

Description will now be given of operation in which an allocation condition including allocation of LPAR shared association is applied to a physical resource management table.

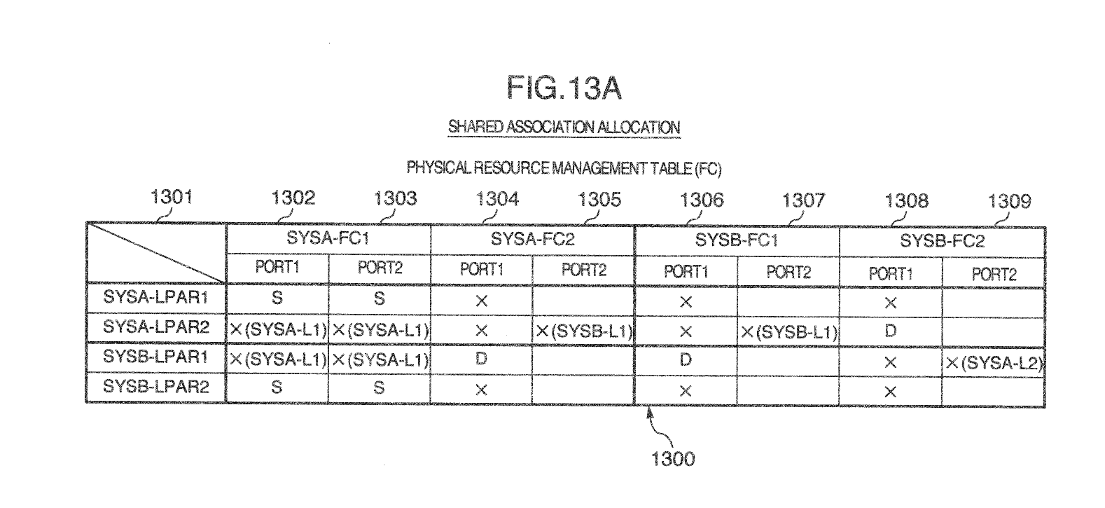

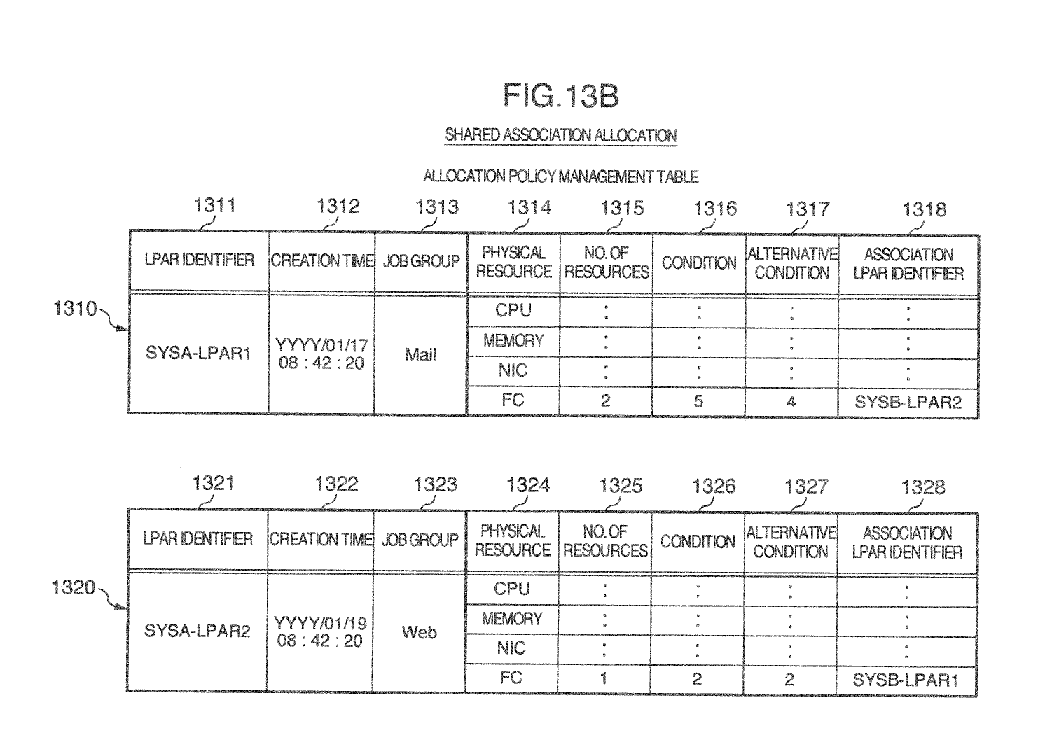

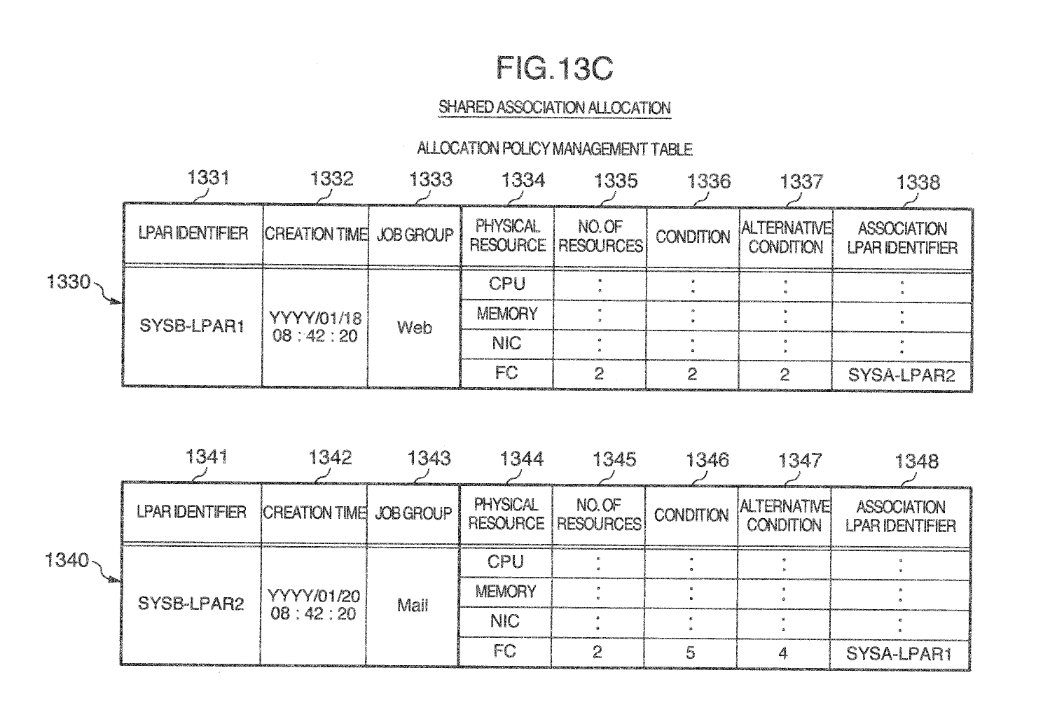

FIGS. 13A to 13C show examples of the physical resource management table and the allocation policy management tables of respective LPARs when an allocation policy management table of an LPAR includes allocation of shared association in two virtual systems. The second embodiment is basically similar in structure to the first embodiment. Assuming that the SAN security has been installed in the LPAR requesting the shared association allocation, a Fibre Channel Card (FC) can be shared only by a particular LPAR. For easy understanding, only FCs are primarily taken into consideration as physical resources. In the description, reference numeral 1300 indicates a physical resource management table (217 in FIG. 3) and reference numerals 1310 to 1340 indicate allocation policy management tables (218 in FIG. 6).

In the allocation policy management table 1310 of LPAR1 (SYSA-LPAR1) of a virtual system operating in physical computer A (101a), the field 1315 indicates two FC devices and the fields 1316 and 1318 indicate that unit shared allocation (allocation condition 5) has been issued with shared association for LPAR2 (SYSB-LPAR2) of a virtual system operating in physical computer B (101b). The field 1317 indicates that the alternative allocation condition is unit shared allocation (allocation condition 4).

In the allocation policy management table 1320 of LPAR2 (SYSA-LPAR2) of a virtual system operating in physical computer A (101a), the field 1325 indicates one FC device and the fields 1326 and 1328 indicate that device occupied allocation (allocation condition 2) has been issued with exclusive association for LPAR1 (SYSB-LPAR1) of a virtual system operating in physical computer B (101b). The field 1317 indicates that the alternative allocation condition is device occupied allocation (allocation condition 2). The allocation conditions of the other LPARs are similar to those described above and hence will not be described.

If the allocation policy management table is applied in the creation order of LPARs, the operation is conducted in the sequence of SYSA-LPAR1, SYSB-LPAR1, SYSA-LPAR2, and SYSB-LPAR2.

According to the allocation policy management table 1310 of SYSA-LPAR1, “S” is filled in the field 1302 for SYSA-LPAR1 of the physical resource management table 1300 and “X (SYSA-L1)” is filled in the fields 1302 other than the field 1302 for SYSB-LPAR2 as an association LPAR. SYSA-LPAR1 requests two FCs. Hence, “S” is filled in the field 1303 for SYSA-LPAR1 and “X (SYSA-L1)” is filled in the fields 1303 other than the field 1303 for SYSA-LPAR2.

Next, based on the allocation policy management table 1330 for SYSB-LPAR1, an attempt is made to fill data in the fields 1302 and 1303 for SYSB-LPAR1 of the physical resource management table 1300. However, “X (SYSA-L1)” has been inserted therein and hence the attempt fails. Since the field 1304 for SYSB-LPAR1 is empty, “D” is filled therein. In the operation, “X” is filled in the fields 1304 other than the field 1304 for SYSB-LPAR1. Since the allocation condition indicates exclusive association with SYSA-LPAR2, “X (SYSB-L1)” is filled in the field 1305 of SYSA-LPAR2 (the other associated fields 1305 are empty). SYSB-LPAR1 requests two FCs. Hence, also for SYSB-FC1 (fields 1306 and 1307), “D” is filled in the field 1306 for SYSB-LPAR1 and “X” is filled in the other associated fields 1306, and “X (SYSB-L1)” is filled in the field 1307 for SYSA-LPAR2.

Next, according to the allocation policy management table 1320 for SYSA-LPAR2, an attempt is made to fill data in the fields 1302 to 1307 for SYSA-LPAR2 of the physical resource management table 1300. However, “X (SYSA-L1)”, “X”, or “X (SYSB-L1)” has been inserted therein; hence, the attempt fails. Since the field 1308 for SYSA-LPAR2 is empty, “D” is filled therein. In the operation, “X” is filled in the associated other fields 1308. Since the allocation condition indicates exclusive association with SYSB-LPAR1, “X (SYSA-L2)” is filled in the field 1309 of SYSB-LPAR1.

Finally, according to the allocation policy management table 1340 for SYSB-LPAR2, an attempt is made to fill data in the field 1302 for SYSB-LPAR2 of the physical resource management table 1300. However, since the field 1302 is empty, “S” is filled therein. SYSB-LPAR2 requests two FCs. Hence, “S” is also filled in the field 1303 for SYSB-LPAR2, to thereby complete the allocation.

By applying the unit shared allocation including LPAR shared association of the embodiment to LPARs in a system including the SAN security and VLAN, independence of the pertinent system from the other systems as well as high security are guaranteed.

### Embodiment 3

Description will now be given of operation in which an allocation condition including alternative allocation is applied to a physical resource management table.

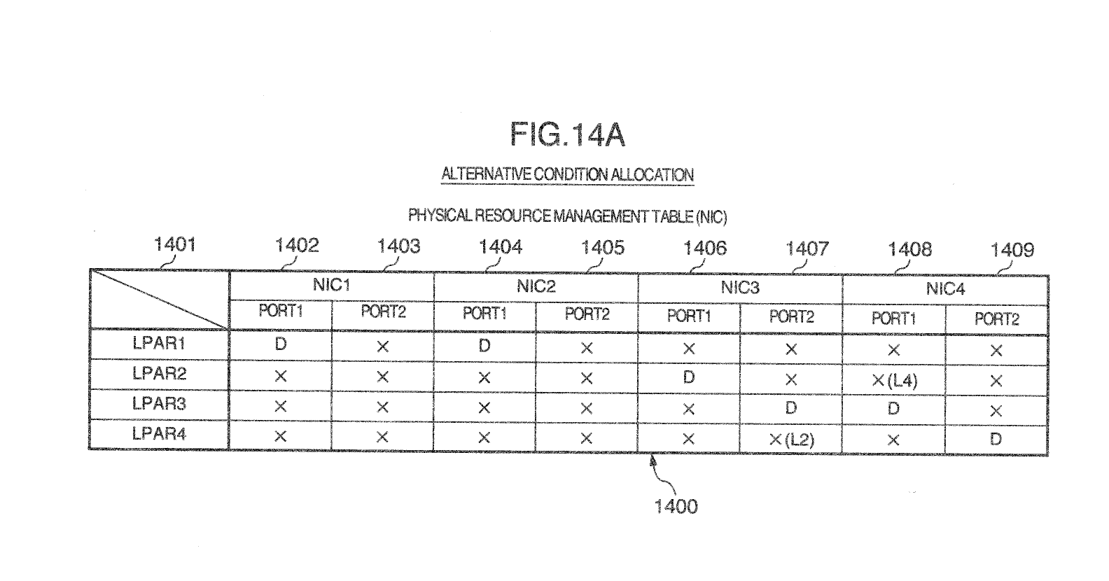

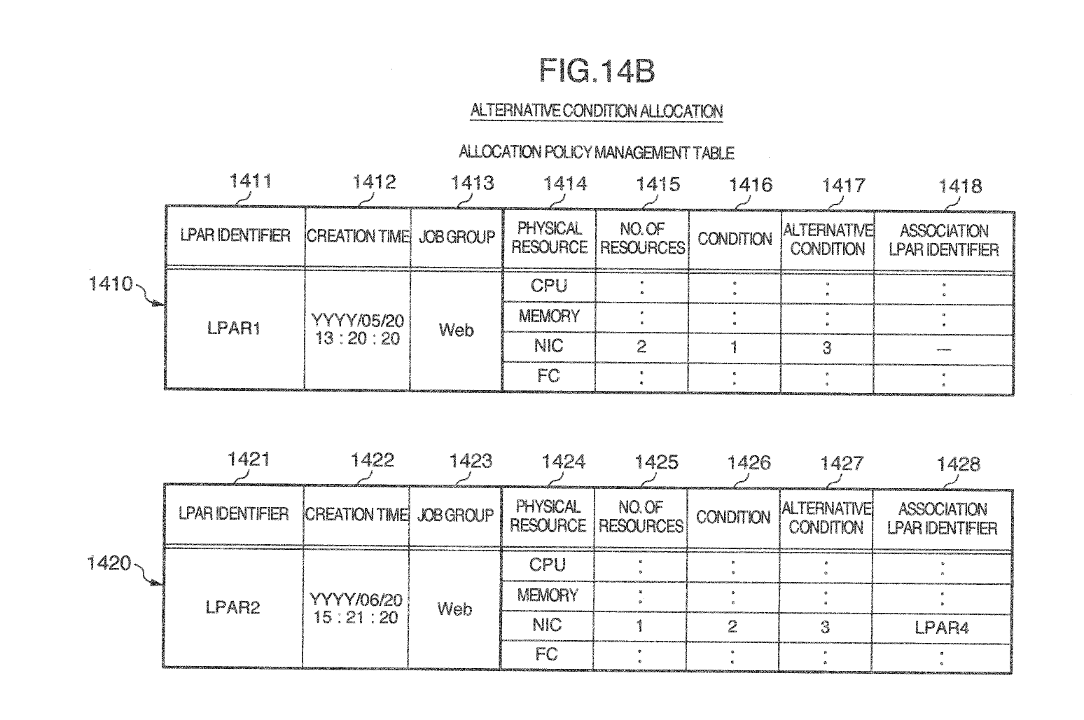

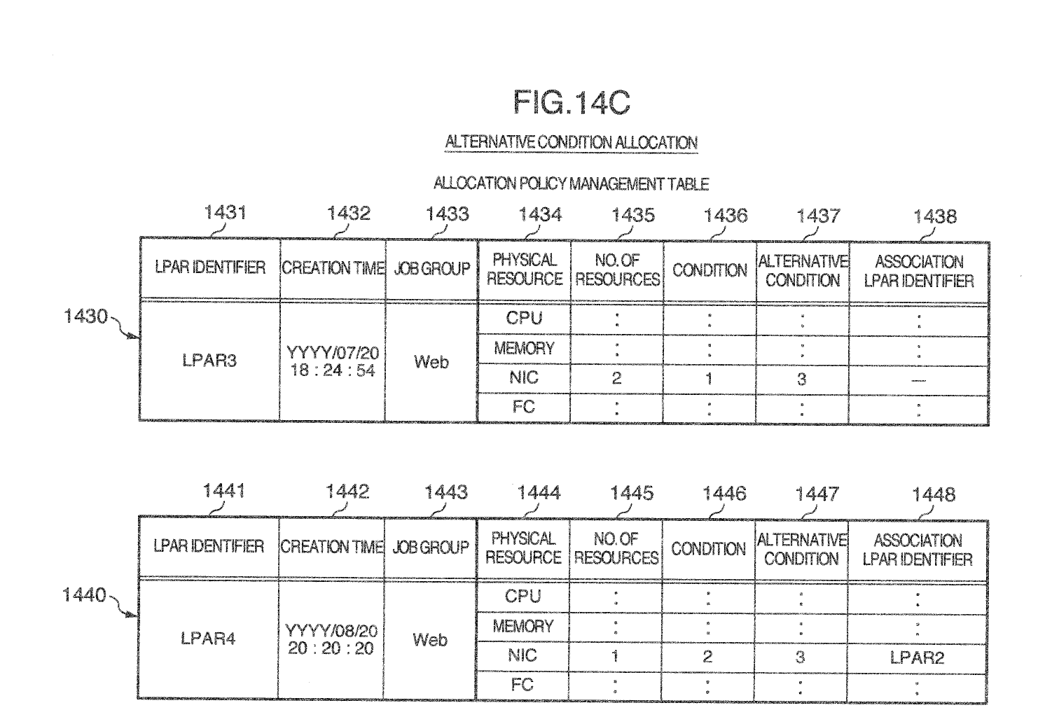

FIGS. 14A to 14C show examples of the physical resource management table and the allocation policy management tables of respective LPARs when the allocation is successfully carried out with an alternative allocation condition in one virtual system. FIGS. 14A to 14C are configured by partly modifying FIGS. 12A to 12C. The third embodiment is basically similar in structure to the first embodiment. For simplicity of explanation, only NICs are primarily taken into consideration as physical resources. In the description, reference numeral 1400 indicates a physical resource management table (217 in FIG. 3) and reference numerals 1410, 1420, 1430, and 1440 indicate allocation policy management tables (218 in FIG. 6).

In the allocation policy management table 1410 of LPAR1, the field 1415 indicates two NIC devices and the field 1416 indicates a request for device occupied allocation (allocation condition 1). The field 1418 indicates that the alternative allocation condition is unit occupied allocation (allocation condition 3).

In the allocation policy management table 1420 of LPAR2, the field 1425 indicates two NIC devices and the fields 1426 and 1428 indicate a request for device occupied allocation (allocation condition 2) with exclusive allocation for LPAR4. The field 1427 indicates that the alternative allocation condition is unit occupied allocation (allocation condition 3). This is also the case with LPAR3 and LPAR4. Hence, description thereof will be omitted.

If the allocation policy management table is applied in the creation order of LPARs, the operation is conducted in the sequence of LPAR1, LPAR2, LPAR3, and LPAR4.

According to the allocation policy management table 1410 of LPAR1, “D” is filled in the field 1402 for LPAR1 of the physical resource management table 1400 and “X” is filledin the other associated fields 1402 and the fields constituting a column 1403. LPAR1 requests two NICs. Hence, also for NIC2 (fields 1404 and 1405), “D” is filled in the field 1404 for LPAR1 and “X” is filled in the other associated fields 1404 and the fields 1405 constituting a column 1405.

Next, based on the allocation policy management table 1420 for LPAR2, an attempt is made to fill data in the fields 1402 to 1405 for LPAR2 of the physical resource management table 1400. However, “X” has been inserted therein and hence the attempt fails. “D” is first filled in the field 1406 of LPAR2. In the operation, “X” is filled in the other associated fields 1406 of LPAR2. Since LPAR2 requests exclusive association for LPAR4, “X (L2)” is filled in the field 1407 of LPAR4 (the other associated fields 1407 are kept empty).

According to the allocation policy management table 1430 for LPAR3, LPAR3 requests, as a physical resource allocation condition, two NIC devices with device occupied allocation. However, according to the physical resource management table 1400, two NIC devices are not available. Hence, an attempt of allocation fails. An allocation attempt is then carried out by using, as the physical resource allocation condition, the alternative allocation condition 3 for two NIC devices with device occupied allocation. An attempt is made to fill in data in the fields 1402 to 1406 of LPAR3. Since “X” has been inserted therein, the attempt fails. The table 1400 includes empty fields beginning at the field 1407 of LPAR3. Hence, “D” is filled in the fields 1407 and 1408, and “X” is filled in the associated other fields 1407 and 1408.

Finally, according to the allocation policy management table 1440 for LPAR4, an attempt is made to fill data in the fields 1402 to 1408 for LPAR4 of the physical resource management table 1400. However, since “X” or “X (L2)” has been filled therein, the attempt fails. The field 1409 of LPAR4 is empty and “X” has been filled in the field 1408 of LPAR2 to be associated under allocation condition 2. According to the state transition table of FIG. 9, this satisfies the allocation condition. Hence, “D” is filled in the field 1409 of LPAR4 and “X” is filled in the other associated fields 1409. In the field 1408 of LPAR2, “X” is changed to “X (L4)”.

By use of the alternative allocation condition of physical resources according to the third embodiment, it is possible to avoid the allocation failure caused in the allocation to all LPARs due to an excessively severe allocation condition.

### Embodiment 4

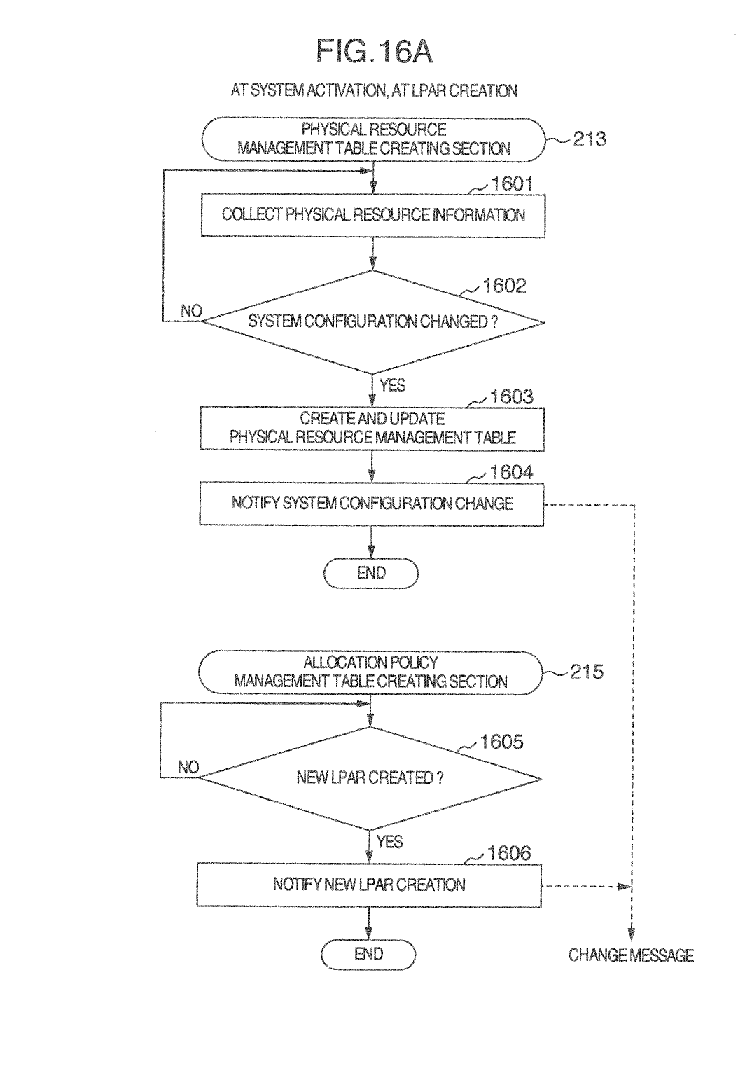

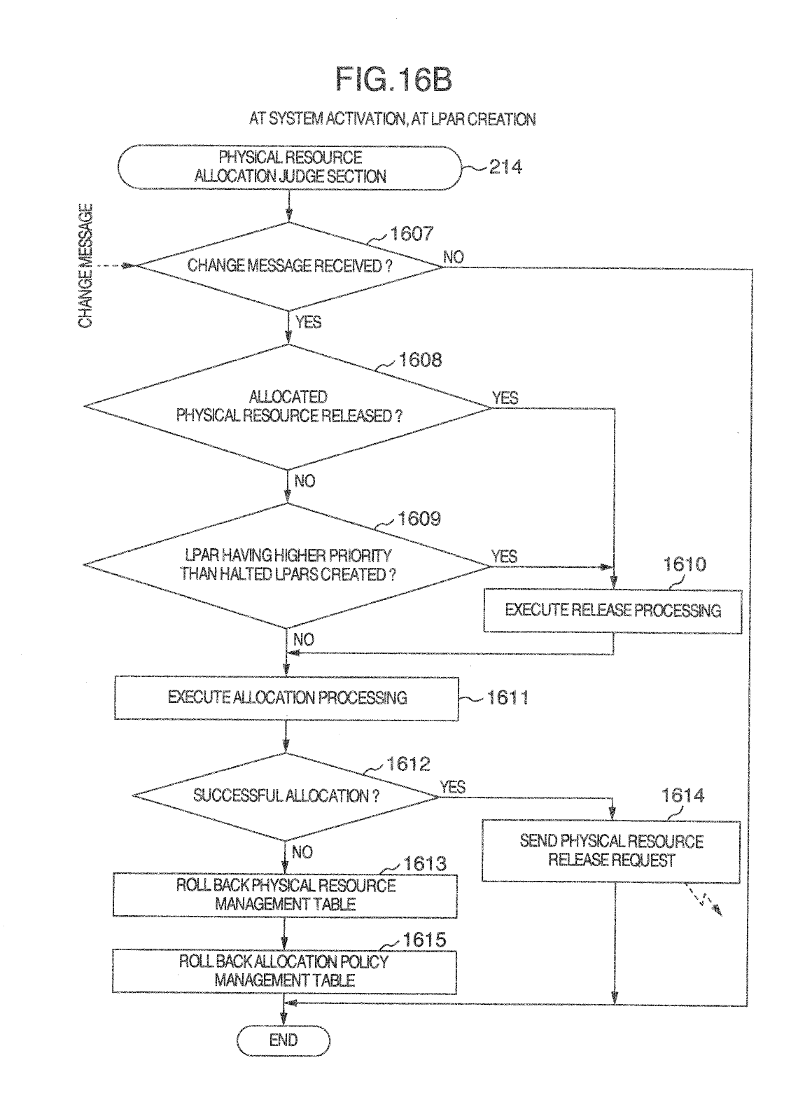

Description will now be given of a relationship between the LPAR life cycle and the present invention by referring to FIGS. 16A and 16B and FIGS. 17 to 19. The fourth embodiment is similar in structure to the first embodiment.

FIGS. 16A and 16B show flowcharts of processing in the physical resource management table creating section, the allocation policy management table creating section, and the physical resource allocation judge section at system activation and at LPAR creation. The processing is executed primarily by the CPU 113.

When a user's request to activate a physical computer is sent to the management computer 111 and a virtual system resultantly starts its operation on the physical computer 101, the physical resource management table creating section 213 issues in step 1601a request to the physical resource information collecting section 211 on the virtual system to collect information. The collecting section 211 collects physical resource information by use of the Baseboard Management Controller (BMC) 107.

In step 1602, the physical resource management table creating section 213 compares the physical resource information collected in step 1601 with physical resources of a virtual system registered to the physical resource management table 217 kept in the management computer 111 to confirm whether or not the system configuration has been changed. If the system configuration has been changed (yes in step 1602), the management table 217 is updated according to the physical resource information in step 1603. Otherwise (no in step 1602), control returns to step 1601. When there exists no physical resource management table 217 and a new system is initialized, it is assumed that the system configuration has been changed (yes in step 1602), and a new physical resource management table 217 is created according to the physical resource information in step 1603.

In step 1604, the physical resource management table creating section 213 notifies the event of the system configuration change (a configuration change message) to the physical resource allocation judge section 214 and then terminates the processing.

On the other hand, at creation of a new LPAR, the allocation policy management table creating section 215 judges by interruption to determine presence or absence of such LPAR creation in step 1605. If the creation is confirmed (yes in step 1605), the table creating section 215 notifies in step 1606 the event of the LPAR creation (a configuration change message) to the physical resource allocation judge section 214 and then terminates the processing.

In the management computer 111, the judge section 214 makes a check in step 1607 to determine whether or not a configuration change notification has been received from the physical resource management table creating section 213 or the allocation policy management table creating section 215. If the notification has been received (yes in step 1607), the judge section 214 goes to step 1608. Otherwise (no in step 1607), the judge section 214 terminates the processing.

In step 1608, a check is made to determine whether or not a physical resource allocated to an LPAR in a halt state has been released. If such physical resource has been released (yes in step 1608), control goes to step 1610. Otherwise (no in step 1608), control goes to step 1609.

In step 1609, a check is made to determine whether or not an LPAR (a new LPAR) having a priority level higher than the LPARs in a halt state has been created. If such LPAR has been created (yes in step 1609), control goes to step 1610. Otherwise (no in step 1609), control goes to step 1611.

In step 1610, if an allocated resource has been released or if the created LPAR is higher in priority than the LPARs in a halt state, the physical resource allocation judge section 214 executes release processing to clear (to an empty state) the fields of the physical resources allocated to the LPAR in the physical resource management table 214. However, this processing is not executed in a case wherein a physical resource has been additionally installed due to a system change.

In step 1611, the allocation processing described in conjunction with FIGS. 10, 11A, and 11B is executed. In step 1612, a check is made to determine whether or not the allocation has been successfully carried out. If it is confirmed in step 1612 that the allocation has been successfully carried out (yes in step 1612), the contents of the physical resource management table 217 and the request to release the physical resource are transmitted in step 1614 to the physical resource allocation managing section 209 in the virtual system and then the processing is terminated. The managing section 209 updates a mapping table between the physical resources kept in the virtual program and the LPARs, to thereby complete the allocation.

If the allocation has not been successfully finished (no in step 1612), the physical resource management table 217 is rolled back in step 1613, the allocation policy management table 218 is rolled back in step 1615 to restore the state immediately before the update. The processing is then terminated.

According to the fourth embodiment, by configuring or modifying systems associated with physical computers, a virtual system can be autonomously constructed.

### Embodiment 5

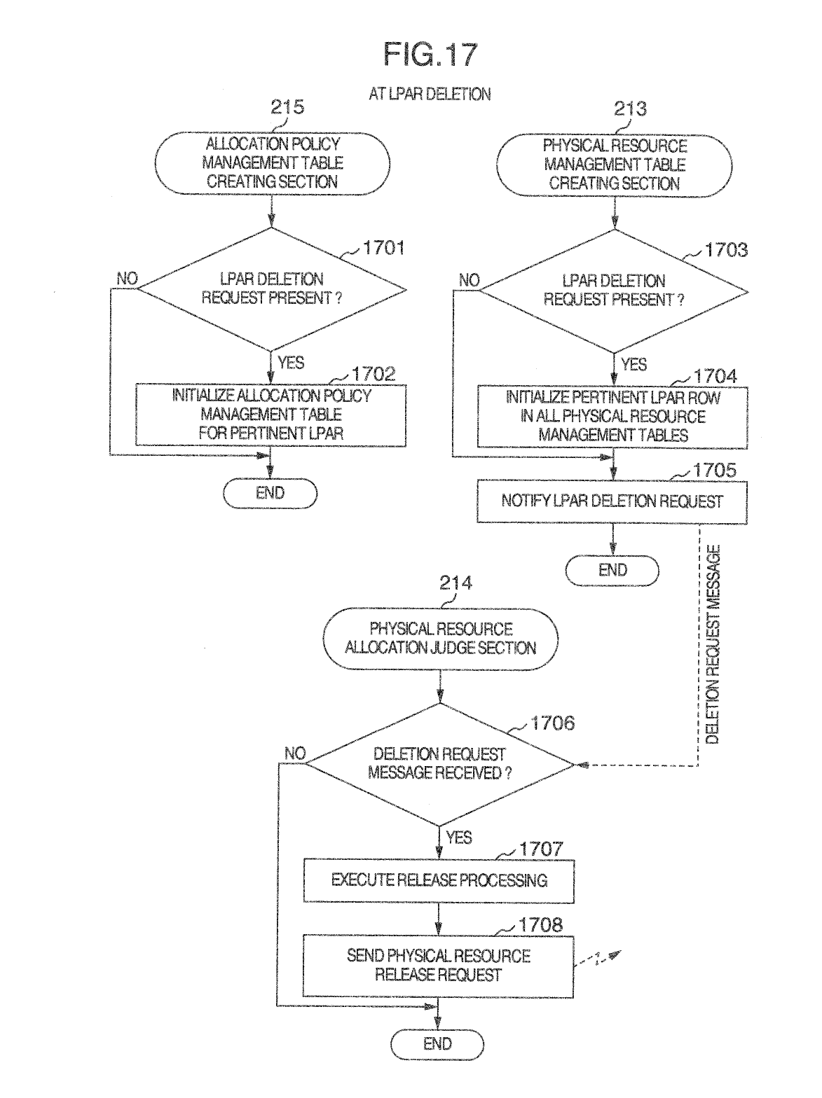

FIG. 17 shows in a flowchart processing to be executed at LPAR deletion, by the physical resource management table creating section, the allocation policy management table creating section, and the physical resource allocation judge section. The CPU 113 primarily executes this processing. At reception of an LPAR deletion request from the user, the target LPAR is halted to delete the physical resource to be allocated.

When the LPAR deletion request is issued from the user, the allocation policy management table creating section 215 in the management computer 111 makes a check in step 1701 to determine whether or not an LPAR deletion request is present. If the request is not present (no in step 1701), the section 215 terminates the processing. Otherwise (yes in step 1701), the section 215 goes to step 1702.

In step 1702, the allocation policy management table creating section 215 clears, in the allocation policy management table 218 of the LPAR, the values other than those set for the LPAR identifier (LPAR name), to thereby initialize the table 218, Thereafter, the processing is terminated.

Concurrently, in the management computer 111, the physical resource management table creating section 213 makes a check in step 1703 to determine whether or not an LPAR deletion request is present. If the request is not present (no in step 1703), the section 213 goes to step 1705. Otherwise (yes in step 1703), the section 213 goes to step 1704.

In step 1704, the physical resource management table creating section 213 clears, in the physical resource management table 217 corresponding to all physical resource types, the values set for the LPAR, to thereby initialize the table 217.

In step 1705, the section 213 notifies the event of the LPAR deletion request (a deletion request message) to the physical resource allocation judge section 214.

In step 1706, the judge section 214 of the management computer 111 judges whether or not an updated physical resource management table 217 has been received as a deletion request message. If the table 217 has not been received (no in step 1706), the judge section 214 terminates the processing. Otherwise (yes in step 1706), the judge section 214 goes to step 1707.

In step 1707, the physical resource allocation judge section 214 executes release processing for the pertinent physical resource and sends in step 1708 a request to release the physical resource to the physical resource allocation executing section 20′9, to thereby terminate the processing.

According to the fifth embodiment, also for the LPAR deletion, a virtual system can be configured in an autonomous fashion.

### Sixth Embodiment

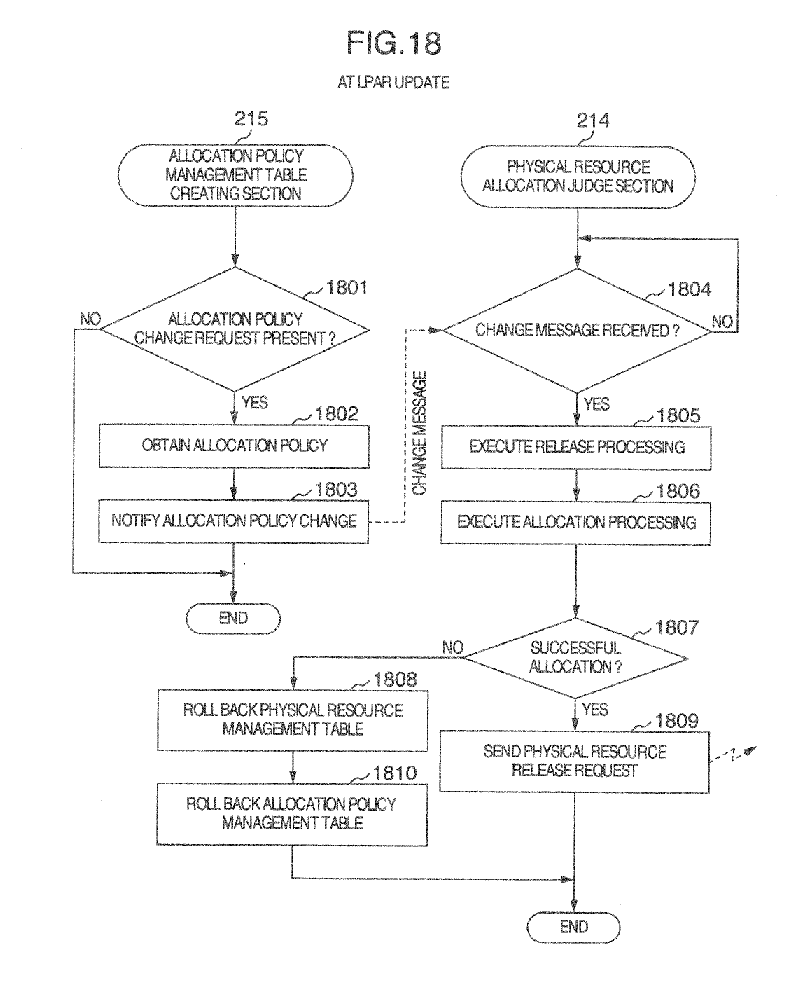

FIG. 18 shows in a flowchart the processing to be executed, at LPAR update, by the allocation policy management table creating section and the physical resource allocation judge section. The CPU 113 mainly executes this processing. The target LPAR is halted to update the physical resource configuration.

When the user updates the allocation policy management table 218, the allocation policy management table creating section 215 makes a check in step 1801 to determine whether or not an allocation policy change request is present. If the request is not present (no in step 1801), the section 215 terminates the processing). Otherwise (yes in step 1801), the section 215 goes to step 1802.

In step 1802, the allocation policy management table creating section 215 obtains an allocation policy and then updates the allocation policy management table 218.

In step 1803, the section 215 notifies the event of the change in the table 218 (a change message) to the physical resource allocation judge section 214.

In the management computer 111, the judge section 214 makes a check by interruption in step 1804 to determine whether or not a change message has been received. If the message has been received (yes in step 1804), the judge section 214 executes processing in step 1805 and subsequent steps.

The processing after this point is similar to that of the physical resource allocation judge section 214 shown in FIG. 6. That is, the processing of steps 1805 to 1810 in FIG. 18 is similar to that of steps 1610 to 1615 in FIG. 16. Hence, the processing of steps 1805 to 1810 will not be described in detail.

According to the sixth embodiment, also for the LPAR update, a virtual system can be configured in an autonomous fashion.

### Seventh Embodiment

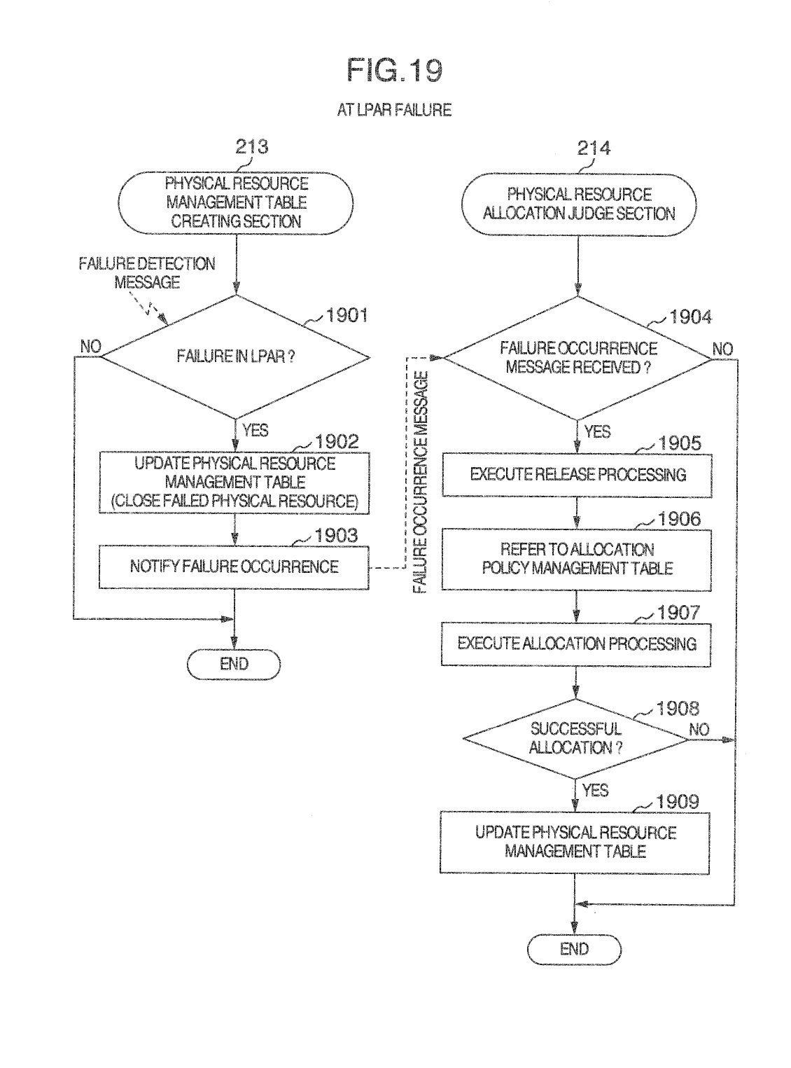

FIG. 19 shows in a flowchart the processing to be executed by the physical resource management table creating section and the physical resource allocation judge section at occurrence of LPAR failure. The CPU 113 primarily executes this processing. When a physical resource fails in an LPAR, the virtual system detects occurrence of the failure and then halts the LPAR (after notification of the detection of the failure).

In the management computer 111, the physical resource management table creating section 213 makes a check in step 1901 to determine whether or not failure has occurred in an LPAR based on a notification of failure detection from the virtual system. If the failure has not occurred (no in step 1901), the section 213 continuously executes the processing. Otherwise (yes in step 1901), the section 213 goes to step 1902.

In step 1902, the section 213 closes, by use of shown in FIG. 5, the failed physical resource in the physical resource management table 217, to thereby update the table 217.

In step 1903, the physical resource management table creating section 213 notifies the event of occurrence of failure in a physical resource (a failure occurrence message) to the physical resource allocation judge section 214.

In step 1904, the judge section 214 of the management computer 111 judges whether or not a failure occurrence message has been received. If the message has not been received (no in step 1904), the judge section 214 terminates the processing. Otherwise (yes in step 1904), the section 214 goes to step 1905.

In step 1905, the judge section 214 refers to the updated physical resource management table 217 to execute release processing for the failed physical resource. In step 1906, the section 214 refers to the allocation policy management table 218.

In step 1907, the physical resource allocation judge section 214 executes allocation processing to allocate an appropriate physical resource to the LPAR according to the management table 218.

In step 1908, the judge section 214 judges whether or not the allocation processing has been successfully completed. If the allocation has been successfully completed (yes in step 1908), the judge section 214 updates the physical resource management table 217 according to the allocation, to thereby terminate the processing. Otherwise (no in step 1908), the judge section 214 terminates the processing.

According to the seventh embodiment, also at occurrence of LPAR failure, a virtual system can be configured in an autonomous fashion.

### Embodiment 8

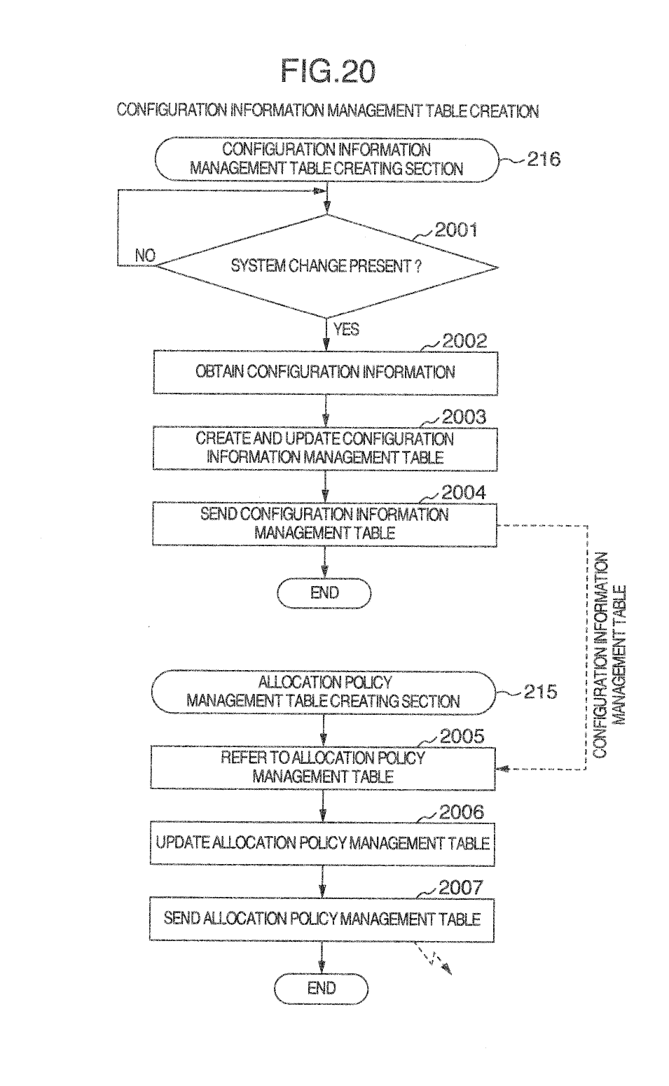

FIG. 20 shows in a flowchart the processing to be executed by the configuration information management table creating section in the management computer. The CPU 113 primarily executes the processing, which is triggered at system update (system setup) and at LPAR creation shown in FIG. 16 and LPAR update shown in FIG. 18. The configuration information collecting section 210, which operates in a virtual system 201 existing in the physical computer 101, includes interfaces for configuration managing software such as HA cluster software between LPARs to collect information thereof. The management computer 111 keeps the information in, for example, the server managing software 212.

In step 2001, the configuration information management table creating section 216 makes a check by interruption to determine whether or not the system configuration has been changed (system change). If the system configuration has been changed (yes in step 2001), the table creating section 216 obtains in step 2002 the configuration kept in the management computer 111 to update in step 2003 the configuration information management table 219 shown in FIG. 15. If no configuration information management table 219 exists in the system setup operation, the section 216 creates a configuration information management table 219.

In step 2004, the section 216 sends the management table 219 to the allocation policy management table creating section 215 of the management computer 111.

In step 2005, when the configuration information management table 219 is received, the table creating section 215 refers to the allocation policy management table 218.

In step 2006, the section 215 updates the allocation policy management table 218 corresponding to each LPAR requesting association. Specifically, the section 215 inputs an LPAR identifier (name) to be associated with the LPAR in an association LPAR identifier field (608 in FIG. 6) of the table 218.

In step 2007, the allocation policy management table creating section 215 sends the associated information of the table 218 to the physical resource allocation judge section 214, to notify the event of the allocation policy change thereto.

The judge section 214 of the management computer 110 recognizes the change information by referring to the allocation policy management table 218 in which the association information (indicating association between particular LPAs) has been updated. When a guest operating system having issued an association request halts at a point of time, a physical resource is allocated in consideration of new association.

As a result, even if the user does not designate any concrete allocation policy, it is possible that the system side identifies an association LPAR to allocate a physical resource in consideration of exclusive and shared association. Hence, only by configuring a system in the conventional physical system, the user can completely construct a virtual system with high reliability and security.

In conjunction with the eighth embodiment, an HA cluster system has been described as an example. However, also for the SAN security and VLAN, the association LPAR can be automatically determined for processing if configuration information similar to that described above is present in the management computer.

### Embodiment 9

Next, description will be given in detail of physical resource allocation according to a ninth embodiment of the present invention.

First, description will be given of physical resource allocation with an allocation condition including weight values.

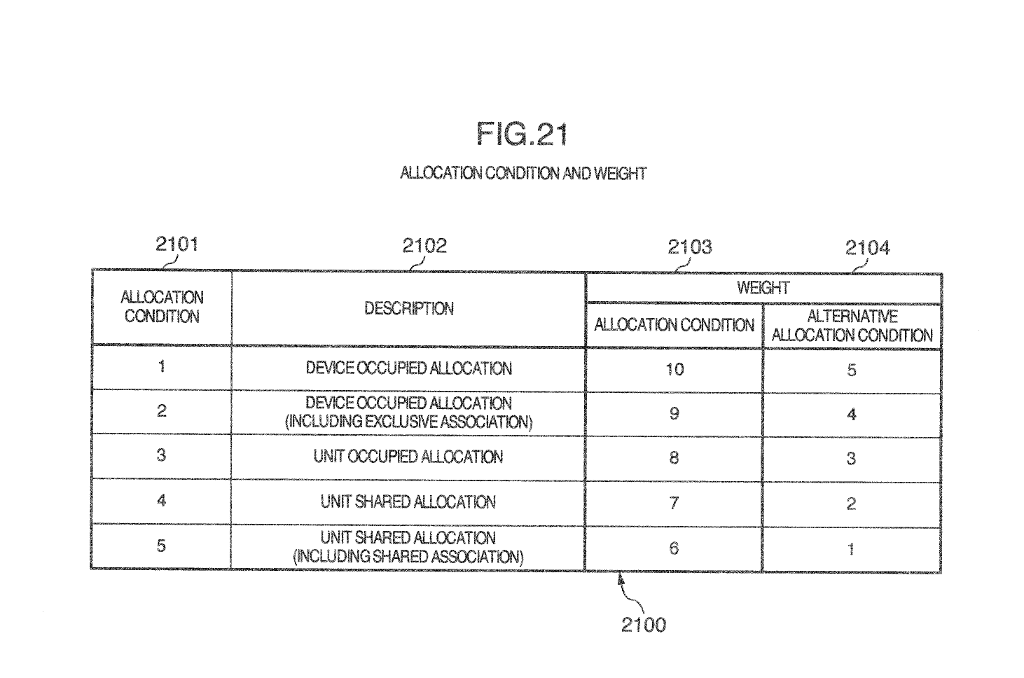

FIG. 21 shows a layout of a correspondence table between allocation conditions and weight values. The user can select an LPAR to which a physical resource is to be preferentially allocated, according to a weight priority order, an LPAR creation order, or a job group order. Table 2100 of FIG. 21 shows priority levels and includes an allocation condition 2101, an allocation condition description 2102, a weight for allocation condition 2103, and a weight for alternative allocation condition 2104.

The allocation condition is employed as an allocation condition or as an alternative allocation condition. In FIG. 21, weights of the allocation conditions are designated for the respective situations. These values are employed only as examples. It is to be appreciated that various weights may be designated depending on purposes.

The weighing operation is for determining a priority when a physical resource to be first allocated is determined according to an allocation request for each physical resource. The larger weight value indicates the higher priority level in the physical resource allocation. However, when one and the same weight value is assigned to two or more physical resources, another weighting scheme may be employed to determine the priority level of each physical resource.

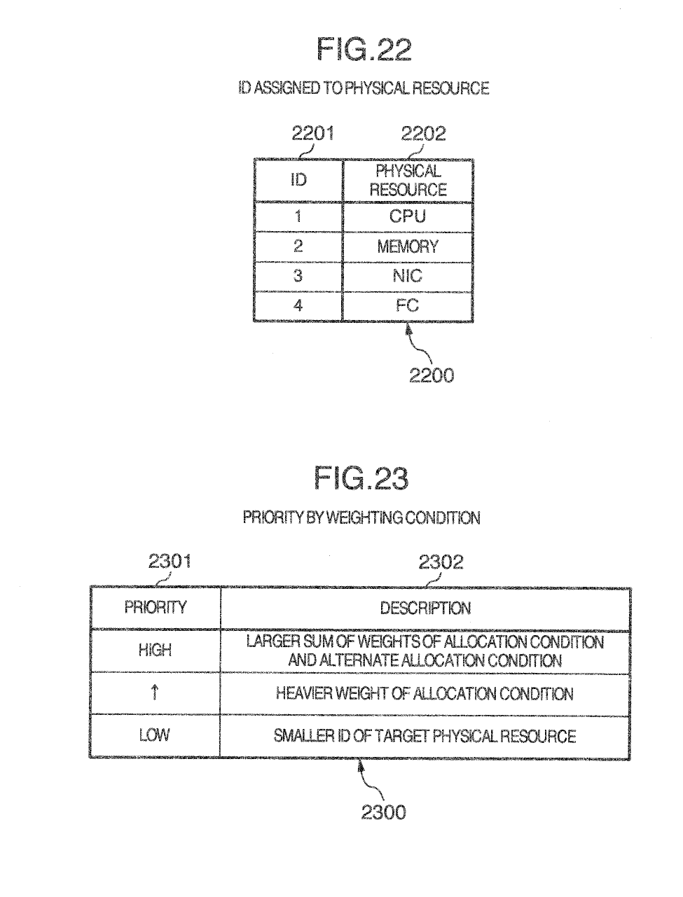

FIG. 22 shows a layout of a correspondence table between identifiers and associated physical resources.

According to the table 2200 of FIG. 22 in which an identifier (ID) 2201 is assigned to each hardware (physical resource) 2202, when one and the same weight value is assigned to, for example, two or more physical resources 2202, it is possible to determine the respective priority levels based on the value of the identifier 2201 assigned to each physical resource 2202.

Description will now be given of determination of the priority levels based on the weighting conditions.

FIG. 23 shows a layout of a correspondence table between priority levels and associated weight values for LPAR selection. In table 2300 of FIG. 23, the field 2301 of second priority information indicates a priority level. The priority level is arranged in a descending order in the column of fields 2301. The field 2302 indicates a detailed condition description of the weighting condition.

According to the conditions in the fields of column 2302, the highest priority is assigned to the physical resource having the largest value of the sum of the values of the allocation condition and the alternative allocation condition. If two physical resources have an equal sum of the values as a result, the physical resource having the larger weight of the allocation condition takes precedence. If these physical resources have an equal value of the weight of the allocation condition, that is, if the resources have an equal sum of weights and an equal allocation condition, a check is made using table 220 of FIG. 22 to set the higher priority to the physical resource having the smaller value of the ID 2201 of hardware (physical resource 2202).

Description will be given of an example to determine a priority level of a physical resource to be selected.

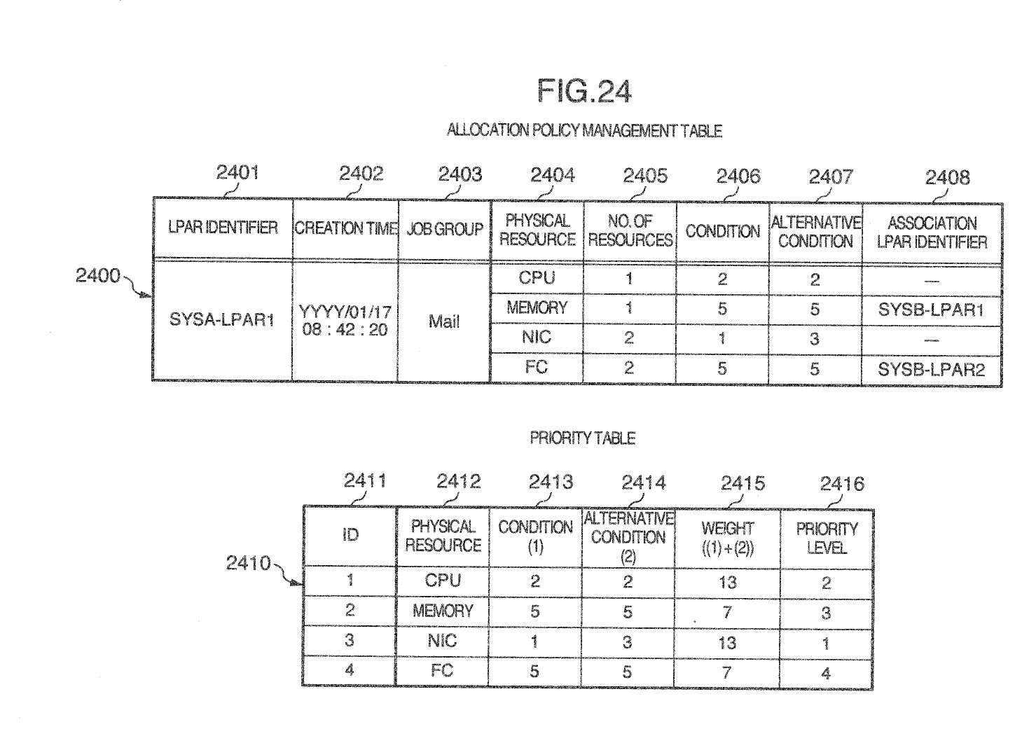

FIG. 24 shows layouts of an allocation policy management table and a priority table indicating priority levels assigned according to the allocation policy management table. For the allocation policy management table 2400 (corresponding to reference numeral 218 of FIG. 6), a table 2410 (first priority information) indicates priority levels for selection in physical resource allocation according to weights of allocation conditions assigned to respective physical resources of each LPAR. The table 2410 includes a physical resource ID 2411, a physical resource indicating its type 2412, a condition indicating a weight for allocation condition 2413, an alternative condition indicating a weight for an alternative of allocation condition 2414, a weight 2415 indicating a sum of the values of fields 2413 and 2414, and a priority level indicating a priority value 2416.

In the management computer 111, the physical resource allocation judge section 214 selects, in step 1004 of FIG. 10, a physical resource to be preferentially allocated on the basis of the priority level.

Description will now be given of an example to determine a priority level of an LPAR to be selected.

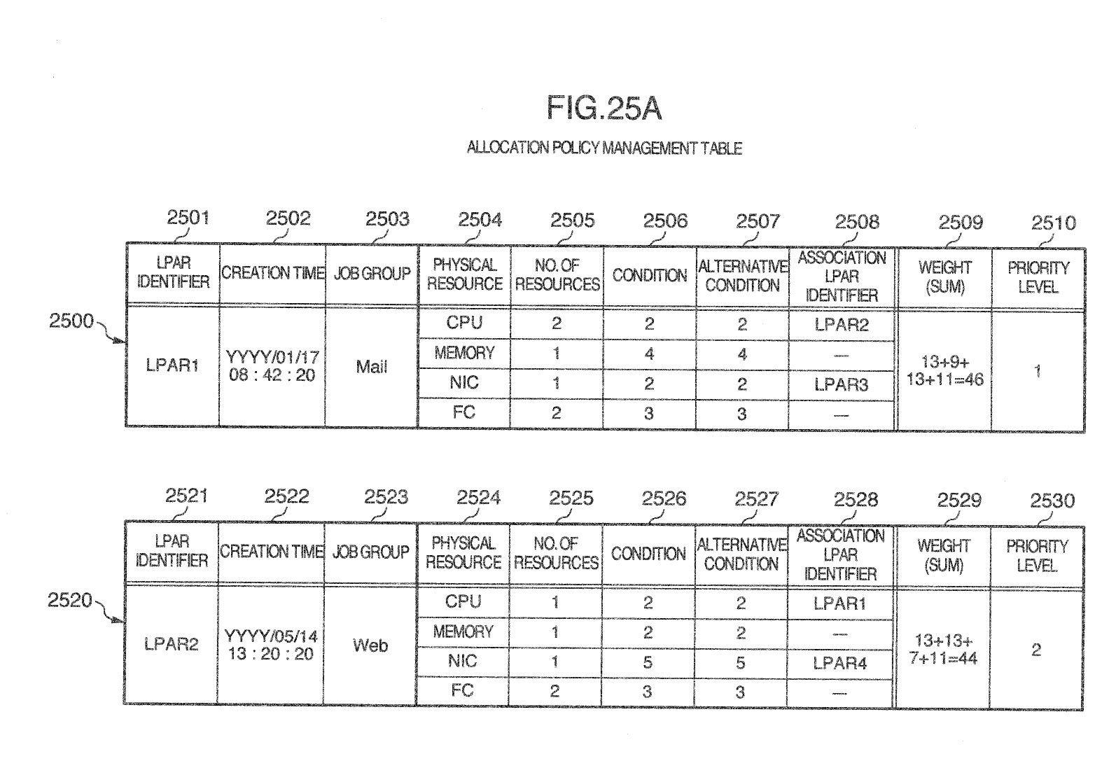

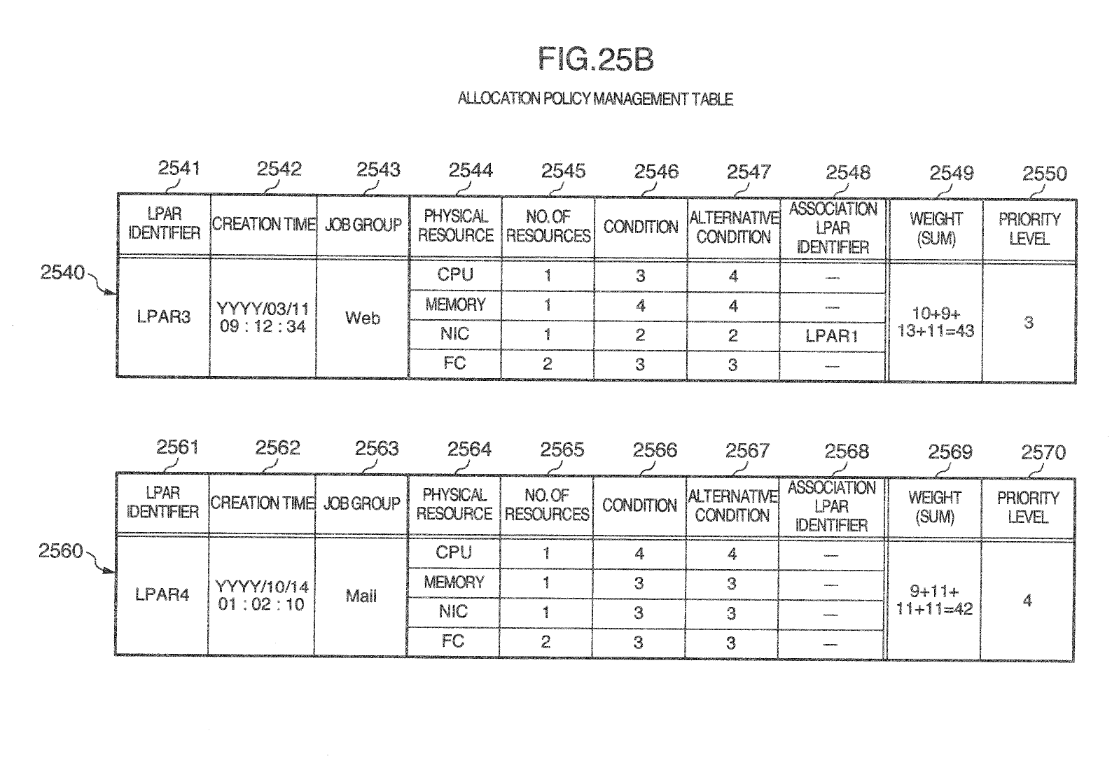

FIGS. 25A and 25B show layouts of allocation policy management tables including LPAR priority levels. For each LPAR, a priority level is determined on the basis of the sum of weights assigned to the respective physical resources of the LPAR. In the allocation policy management tables 2500, 2520, 2540, and 2560 (corresponding to reference numeral 218 of FIG. 6) associated respectively with LPARs 1 to the fields 2509, 2529, 2549, and 2569 respectively indicate the sums of weights for respective allocations and the fields 2510, 2530, 2550, and 2570 respectively indicate the priority levels of the respective LPARs.

In the management computer 111, the physical resource allocation judge section 214 selects, in step 1002 of FIG. 10, an LPAR for preferential allocation on the basis of the priority level. In other words, the allocation policy management tables are applied in an order of LPAR1 to LPAR4 (reference is to be made to the priority level 2510, 2530, 2550, or 2570).

However, the priority determination procedure is not limited to that of FIG. 23 in which the weighting condition is employed. For example, the priority may be determined according to the priority level in the LPAR creation order or on the basis of job groups.

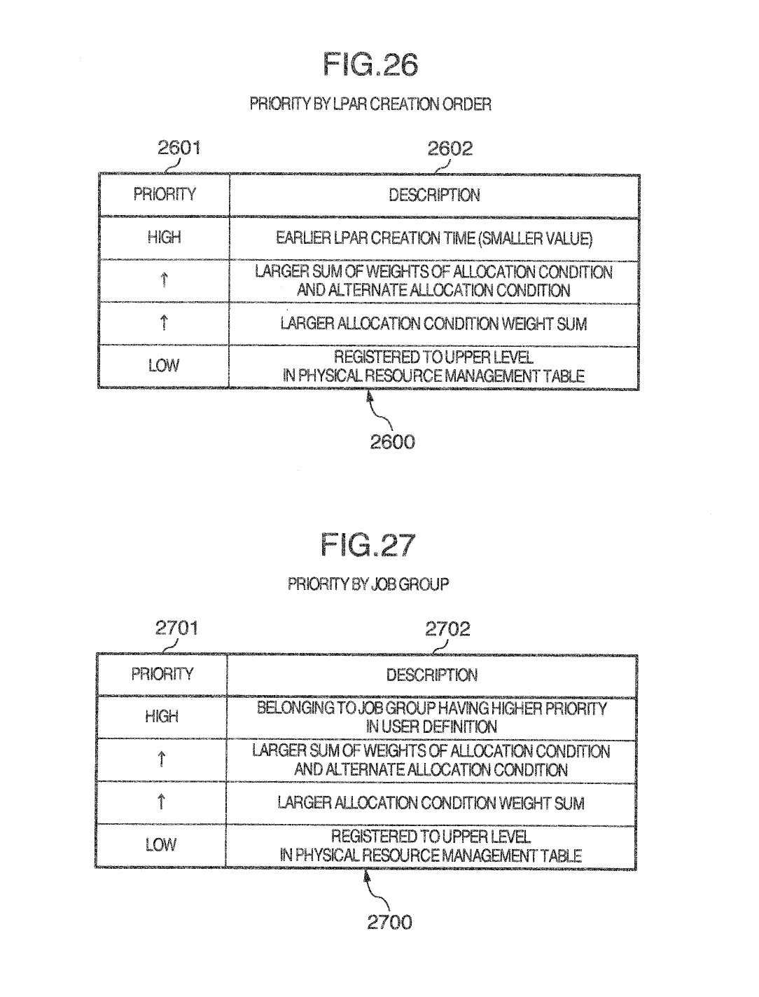

FIG. 26 shows a layout of a priority table of LPAR selection priority levels arranged in the LPAR creation order. In the table 2600 (second priority information), a field 2601 indicates a priority level and fields 2601 constituting a column are arranged in a descending order of priority levels. A field 2602 indicates a condition (description) of details of a weighting condition including a creation time of each LPAR.

In the table 2600, the allocation is preferentially carried out in an ascending order of LPAR creation times. If two or more LPARs have one and the same creation time, the priority is determined on the basis of the subsequent priority conditions in the table 2600. If the LPARs have an equal sum of weight values of allocation and alternative allocation conditions and an equal sum of weight values of allocation conditions, the priority level cannot be determined. In this situation, a higher priority level is assigned to an LPAR registered to a higher position in the physical resource management table 217 (having a smaller LPAR identifier value).

FIG. 27 shows a layout of a priority table of priority levels for LPAR selection arranged according to job groups. In the table 2700 (second priority information), a field 2701 indicates a priority level and fields 2701 constituting a column are arranged in a descending order of priority levels. A field 2702 indicates a condition (description) of details of a weighting condition including a property of each job group.

In the table 2700, the group name includes a group name specified by the user for the allocation policy. The priority between job groups is designated by the user at physical resource allocation. If LPARs have an equal job group, the LPAR for allocation is determined on the basis of the subsequent priority conditions in the table 2700. If such LPAR is not determined according to the conditions as in the case of the LPAR creation order, a higher priority level is assigned to an LPAR registered to a higher position in the physical resource management table 217 (having a smaller LPAR identifier value).

These tables of priority and priority levels are stored, for example, as data in the memory 114 of the management computer 111.

### <<Effect>>

According to the ninth embodiment, the user can construct a virtual system through almost the same number of steps as for the environment construction in a physical system. Therefore, the user can advantageously construct a highly reliable system in which the double failure due to failure in one and the same physical resource in an HA cluster system is prevented and in which consideration is given to the VLAN and SAN security.

Even during the operation of the system, the re-allocation of a physical resource can be conducted according to the allocation policy. Hence, to an LPAR which has been once deleted or to an LPAR in which failure has occurred, an appropriate physical resource can be advantageously allocated at subsequent creation thereof, and the LPAR can be directly set to an operation state.

### <<Modifications>>

The present invention is not restricted by those embodiments. The embodiments can be changed or modified in various ways.

For example, the present invention is applicable also to one LPAR which operates under control of two or more hypervisors in two or more physical computers.

The hardware, the software, the tables, and the flowcharts described above may be appropriately changed or modified in specific configurations without departing from the scope and spirit of the present invention.

1. A management computer communicably connected to at least one physical computer constituting at least one virtual computer for making the physical computer allocate physical resources of the physical computer to the virtual computer, comprising:
a storage section for storing therein physical resource managing information determining, for each virtual computer, allocation states of the physical resources and allocation condition managing information determining, for each virtual computer, an allocation condition which is determined for each of the physical resources and which includes a condition regarding allocation of the physical resource; and
control section for performing
control to select a virtual computer at predetermined timing and to obtain, based on the allocation condition managing information, an allocation condition of a physical resource allocated to the virtual computer,
control to select one of the physical resources allocated to the virtual computer and to obtain an allocation state of the physical resource based on the physical resource managing information,
control to judge whether or not allocation satisfying the allocation condition is possible based on the allocation state and to update, if the allocation is possible, the physical resource managing information to reflect the allocation therein, and
control to make each virtual computer execute the allocation to an associated physical computer if the allocation is possible.

2. A management computer according to claim 1, wherein the predetermined timing is when the physical computer is activated, when the virtual computer is created, when the allocation condition is changed, or when the virtual computer fails.

3. A management computer according to claim 1, wherein the physical resources handled in the physical resource managing information or the allocation condition managing information are determined for each device constituting the physical computer or for each unit constituting the device.

4. A management computer according to claim 1, wherein the allocation condition includes, among a plurality of virtual computers to which a request of exclusive allocation of the physical resource is issued, an allocation condition with exclusive association in which allocation of one and the same physical resource of one and the same type is inhibited.

5. A management computer according to claim 1, wherein the allocation condition includes, only among a plurality of virtual computers to which a request of shared allocation of the physical resource is issued, an allocation condition with shared association in which allocation of one and the same physical resource of one and the same type is conducted.

6. A management computer according to claim 1, wherein the allocation condition managing information includes an alternative allocation condition which is employed, if it is determined as a result of the judgment that the allocation satisfying the allocation condition is not possible, to substitute for the allocation condition, and which makes the control section judge whether or not allocation satisfying a second condition less severe than the allocation condition is possible, according to the allocation state.

7. A management computer according to claim 1, wherein:
the storage section stores therein configuration information managing information which is obtained from the physical computer and which determines, for each virtual computer, configuration information including information regarding association of allocation of physical resources determined among virtual computers; and
the control section performs control to create, according to the configuration information of the configuration information managing information, the allocation condition managing information determined for a virtual computer.

8. A management computer according to claim 1, wherein:
the storage section stores therein first priority information which is determined according to the allocation condition and which determines priority of a physical resource; and
the control section performs, in the selection of the physical resource, control to conduct the selection in a descending order of priority of physical resources by referring to the first priority information.

9. A management computer according to claim 8, wherein:
the storage section stores therein second priority information which is determined according to the first priority information and which determines priority of a virtual computer to which the physical resource is allocated; and
the control section performs, in the selection of the virtual computer, control to conduct the selection in a descending order of priority of virtual computers.

10. A computer system wherein at least one physical computer constituting at least one virtual computer is communicably connected to a management computer which makes the physical computer allocate physical resources of the physical computer to the virtual computer, wherein, the management computer comprises:
a storage section for storing therein physical resource managing information determining, for each virtual computer, allocation states of the physical resources and allocation condition managing information determining, for each virtual computer, an allocation condition which is determined for each of the physical resources and which includes a condition regarding allocation of the physical resource; and
control section for performing
control to select a virtual computer at predetermined timing and to obtain, based on the allocation condition managing information, an allocation condition of a physical resource allocated to the virtual computer,
control to select one of the physical resources allocated to the virtual computer and to obtain an allocation state of the physical resource based on the physical resource managing information,
control to judge whether or not allocation satisfying the allocation condition is possible based on the allocation state and to update, if the allocation is possible, the physical resource managing information to reflect the allocation therein, and
control to make each virtual computer execute the allocation to an associated physical computer if the allocation is possible.

11. A physical resource allocation method for use with a management computer communicably connected to at least one physical computer constituting at least one virtual computer for making the physical computer allocate physical resources of the physical computer to the virtual computer, wherein:
the management computer stores therein
physical resource managing information determining, for each virtual computer, allocation states of the physical resources and
allocation condition managing information determining, for each virtual computer, an allocation condition which is determined for each of the physical resources and which includes a condition regarding allocation of the physical resource; and
the management computer comprises control section for executing
a step of selecting a virtual computer at predetermined timing and obtaining, based on the allocation condition managing information, an allocation condition of a physical resource allocated to the virtual computer,
a step of selecting one of the physical resources allocated to the virtual computer and obtaining an allocation state of the physical resource based on the physical resource managing information,
a step of judging whether or not allocation satisfying the allocation condition is possible based on the allocation state and updating, if the allocation is possible, the physical resource managing information to reflect the allocation therein, and
a step of making each virtual computer execute the allocation to an associated physical computer if the allocation is possible.

12. A physical resource allocation method according to claim 11, wherein the predetermined timing is when the physical computer is activated, when the virtual computer is created, when the allocation condition is changed, or when the virtual computer fails.

13. A physical resource allocation method according to claim 11, wherein the physical resources handled in the physical resource managing information or the allocation condition managing information are determined for each device constituting the physical computer or for each unit constituting the device.

14. A physical resource allocation method according to claim 11, wherein the allocation condition includes, among a plurality of virtual computers to which a request of exclusive allocation of the physical resource is issued, an allocation condition with exclusive association in which allocation of one and the same physical resource of one and the same type is inhibited.

15. A physical resource allocation method according to claim 11, wherein the allocation condition includes, only among a plurality of virtual computers to which a request of shared allocation of the physical resource is issued, an allocation condition with shared association in which allocation of one and the same physical resource of one and the same type is conducted.

16. A physical resource allocation method according to claim 11, wherein the allocation condition managing information includes an alternative allocation condition which is employed, if it is determined as a result of the judgment that the allocation satisfying the allocation condition is not possible, to substitute for the allocation condition, and which makes the control section judge whether or not allocation satisfying a second condition less severe than the allocation condition is possible, according to the allocation state.

17. A physical resource allocation method according to claim 11, wherein:
the management computer stores therein configuration information managing information which is obtained from the physical computer and which determines, for each virtual computer, configuration information including information regarding association of allocation of physical resources determined among virtual computers; and
the control section executes a step of creating the allocation condition managing information determined for a virtual computer, according to the configuration information of the configuration information managing information.

18. A physical resource allocation method according to claim 11, wherein:
the storage section stores therein first priority information which is determined according to the allocation condition and which determines priority of a physical resource; and
the control section executes, in the selection of the physical resource, a step of conducting the selection in a descending order of priority of physical resources by referring to the first priority information.

19. A physical resource allocation method according to claim 18 wherein:
the storage section stores therein second priority information which is determined according to the first priority information and which determines priority of a virtual computer to which the physical resource is allocated; and
the control section performs, in selection of the virtual computer, control to conduct the selection in a descending order of priority of virtual computers.
